(19) United States
(12) Patent Application Publication
(10) Pub. No.: US 2024/0414592 A1
(43) Pub. Date: Dec. 12, 2024

(54) METHOD FOR WIRELESS COMMUNICATION, AND DEVICES

(71) Applicant: GUANGDONG OPPO MOBILE TELECOMMUNICATIONS CORP., LTD., Dongguan (CN)

(72) Inventor: Yang XU, Dongguan (CN)

(21) Appl. No.: 18/807,225

(22) Filed: Aug. 16, 2024

Related U.S. Application Data
(63) Continuation of application No. PCT/CN2022/083868, filed on Mar. 29, 2022.

(51) Int. Cl. H04W 28/08; H04W 28/20; H04W 60/04

(52) U.S. Cl. CPC H04W 28/0925; H04W 28/20; H04W 60/04

(57) ABSTRACT

Provided is a method for wireless communication. The method is applicable to a terminal device, and includes: transmitting first information to a first core network element, wherein the first information indicates whether the terminal device supports configuring a policy rule in a second communication system, the first core network element is a core network element in a first communication system, and the first communication system is different from the second communication system.

### CROSS-REFERENCE TO RELATED APPLICATION

This application is a continuation application of International Application No. PCT/CN2022/083868, filed on Mar. 29, 2022, the entire contents of which are incorporated herein by reference.

### TECHNICAL FIELD

Embodiments of the present disclosure relates to the technical field of communications, and in particular, relate to a method and apparatus for wireless communication, a communication device, and a storage medium and a program product thereof.

### BACKGROUND

A core network is capable of providing some policy rules to a terminal device, for example, a user equipment (UE) route selection policy (URSP), an access network discovery and selection policy (ANDSP), and the like, such that the terminal device is capable of more reliably and efficiently communicating with a network side.

### SUMMARY

Embodiments of the present disclosure provide a method and apparatus for wireless communication, a communication device, and a storage medium and a program product thereof. The technical solutions are as follows.

According to some embodiments of the present disclosure, a method for wireless communication is provided. The method is applicable to a terminal device, and includes:
transmitting first information to a first core network element, wherein the first information indicates support or allowance of a policy rule on the terminal device in a case that the terminal device is connected to a second communication system; and/or
receiving second information from a first core network element, wherein the second information indicates support or allowance of a policy rule on the network in a case that the terminal device is connected to a second communication system;
wherein the first core network element is a core network element in a first communication system, and the first communication system is different from the second communication system.

According to some embodiments of the present disclosure, a method for wireless communication is provided. The method is applicable to a first core network element, and includes:
receiving first information from a terminal device, wherein the first information indicates support or allowance of a policy rule on the terminal device in a case that the terminal device is connected to a second communication system; and/or
transmitting second information to a terminal device, wherein the second information indicates support or allowance of a policy rule on a network in a case that the terminal device is connected to a second communication system;
wherein the first core network element is a core network element in a first communication system, and the first communication system is different from the second communication system.

According to some embodiments of the present disclosure, a method for wireless communication is provided. The method is applicable to a terminal device, and includes:
receiving third information from a first core network element, wherein the first core network element is a core network element in a first communication system, the third information indicates a policy rule used on the terminal device in a second communication system, and the first communication system is different from the second communication system.

According to some embodiments of the present disclosure, a method for wireless communication is provided. The method is applicable to a terminal device, and includes:
receiving fourth information from a first core network element, wherein the fourth information indicates a policy rule used on the terminal device in a first communication system, and the first core network element is a core network element in a first communication system; and
determining, based on the policy rule used in the first communication system, a policy rule used in a second communication system, wherein the first communication system is different from the second communication system.

According to some embodiments of the present disclosure, a method for wireless communication is provided. The method is applicable to a first core network element, and includes:
transmitting third information to a terminal device, wherein the first core network element is a core network element in a first communication system, the third information indicates a policy rule used on the terminal device in a second communication system, and the first communication system is different from the second communication system.

According to some embodiments of the present disclosure, a method for wireless communication is provided. The method is applicable to a first core network element, and includes:
transmitting fourth information to a terminal device, wherein the fourth information indicates a policy rule used on the terminal device in a first communication system, wherein the policy rule used in the first communication system is configured to determine a policy rule used in the second communication system; wherein the first core network element is a core network element in a first communication system, and the first communication system is different from the second communication system.

According to some embodiments of the present disclosure, an apparatus for wireless communication is provided. The apparatus includes:
a transmitting module, configured to transmit first information to a first core network element, wherein the first information indicates support or allowance of a policy rule on a terminal device in a case that the terminal device is connected to a second communication system; and/or
a receiving module, configured to receive second information from a first core network element, wherein the second information indicates support or allowance of a policy rule on a network in a case that a terminal device is connected to a second communication system;
wherein the first core network element is a core network element in a first communication system, and the first communication system is different from the second communication system.

According to some embodiments of the present disclosure, an apparatus for wireless communication is provided. The apparatus includes:
a receiving module, configured to receive first information from a terminal device, wherein the first information indicates support or allowance of a policy rule on the terminal device in a case that the terminal device is connected to a second communication system; and/or
a transmitting module, configured to transmit second information to a terminal device, wherein the second information indicates support or allowance of a policy rule on a network in a case that the terminal device is connected to a second communication system;
wherein a first core network element is a core network element in a first communication system, and the first communication system is different from the second communication system.

According to some embodiments of the present disclosure, an apparatus for wireless communication is provided. The apparatus includes:
a receiving module, configured to receive third information from a first core network element, wherein the first core network element is a core network element in a first communication system, the third information indicates a policy rule used on a terminal device in a second communication system, and the first communication system is different from the second communication system.

According to some embodiments of the present disclosure, an apparatus for wireless communication is provided. The apparatus includes:
a receiving module, configured to receive fourth information from a first core network element, wherein the fourth information indicates a policy rule used on a terminal device in a first communication system, and the first core network element is a core network element in a first communication system; and
a processing module, configured to determine, based on the policy rule used in the first communication system, a policy rule used in a second communication system, wherein the first communication system is different from the second communication system.

According to some embodiments of the present disclosure, an apparatus for wireless communication is provided. The apparatus includes:
a transmitting module, configured to transmit third information to a terminal device, wherein a first core network element is a core network element in a first communication system, the third information indicates a policy rule used on the terminal device in a second communication system, and the first communication system is different from the second communication system.

According to some embodiments of the present disclosure, an apparatus for wireless communication is provided. The apparatus includes:
a transmitting module, configured to transmit fourth information to a terminal device, wherein the fourth information indicates a policy rule used on the terminal device in a first communication system, wherein the policy rule used in the first communication system is configured to determine a policy rule used in the second communication system, wherein a first core network element is a core network element in a first communication system, and the first communication system is different from the second communication system.

According to some embodiments of the present disclosure, a communication device is provided. The communication device includes: a processor and a memory storing one or more computer programs; wherein the processor, when loading and running the one or more computer programs, is caused to perform the method for wireless communication applicable to the terminal device or the method for wireless communication applicable to the first core network element.

According to some embodiments of the present disclosure, a computer-readable storage medium is provided. The computer-readable storage medium stores one or more computer programs, wherein the one or more computer programs, when loaded and run by a processor, cause the processor to perform the method for wireless communication applicable to the terminal device or the method for wireless communication applicable to the first core network element.

According to some embodiments of the present disclosure, a chip is provided. The chip includes programmable logical circuity and/or program instructions, wherein the chip, when running, is caused to perform the method for wireless communication applicable to the terminal device or the method for wireless communication applicable to the first core network element.

According to some embodiments of the present disclosure, a computer program product is provided. The computer program product includes one or more computer instructions, wherein the one or more computer instructions are stored in a computer-readable storage medium, wherein a processor, when reading, loading, and executing the one or more computer instructions from the computer-readable storage medium, is caused to perform the method for wireless communication applicable to the terminal device or the method for wireless communication applicable to the first core network element.

### BRIEF DESCRIPTION OF DRAWINGS

FIG. 1 is a schematic diagram of a network architecture according to some embodiments of the present disclosure;

FIG. 2 is an architecture diagram of a 5^{th} generation (5G) system according to some embodiments of the present disclosure;

FIG. 3 is an architecture diagram of a 5G system according to some embodiments of the present disclosure;

FIG. 4 is a flowchart of a method for wireless communication according to some embodiments of the present disclosure;

FIG. 5 is a flowchart of policy rule negotiation of a UE and a 5G network according to some embodiments of the present disclosure;

FIG. 6 is a flowchart of a method for wireless communication according to some embodiments of the present disclosure;

FIG. 7 is a schematic diagram of transmission of third information by a policy and charging rules function (PCRF) based on a public data network (PDN) gateway (P-GW) initiated bearer modification procedure according to some embodiments of the present disclosure;

FIG. 8 is a schematic diagram of transmission of fourth information by a UE based on an attach or tracking area update procedure according to some embodiments of the present disclosure;

FIG. 9 is a schematic diagram of mapping of a route selection descriptor (RSD) of a 5G system (5GS) and an RSD of an evolved packet system (EPS) with a same traffic descriptor according to some embodiments of the present disclosure;

FIG. 10 is a schematic diagram of transmission of third information by a policy control function (PCF) based on a UE configuration update (UCU) procedure according to some embodiments of the present disclosure;

FIG. 11 is a flowchart of a method for wireless communication according to some embodiments of the present disclosure;

FIG. 12 is a schematic block diagram of an apparatus for wireless communication according to some embodiments of the present disclosure;

FIG. 13 is a schematic block diagram of an apparatus for wireless communication according to some embodiments of the present disclosure;

FIG. 14 is a schematic structural diagram of a terminal device according to some embodiments of the present disclosure; and

FIG. 15 is a schematic structural diagram of a network device according to some embodiments of the present disclosure.

### DETAILED DESCRIPTION

For clearer descriptions of the objectives, technical solutions, and advantages of the present disclosure, embodiments of the present disclosure are described in detail hereinafter in conjunction with the accompanying drawings.

The network architecture and traffic scenarios in the embodiments of the present disclosure are intended to describe the technical solutions according to the embodiments of the present disclosure clearer, and are not construed as limitations on the technical solutions according to the embodiments of the present disclosure. It can be understood by those of ordinary skill in the art that with the evolution of the network architecture and occurrence of new traffic scenarios, the technical solutions according to the embodiments of the present disclosure are also applicable to solving similar technical problems.

The technical solutions according to the embodiments of the present disclosure are applicable to various communication systems, for example, a global system of mobile communications (GSM) system, a code-division multiple access (CDMA) system, a wideband code-division multiple access (WCDMA) system, a general packet radio service (GPRS) system, a long-term evolution (LTE) system, an advanced long-term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a universal mobile telecommunications system (UMTS), a wireless local area network (WLAN), a wireless fidelity (Wi-Fi) system, a 5G system, or other communication systems.

In general, a conventional communication system supports a limited number of connections and is easy to implement. However, with the development of communications technologies, the mobile communication system supports traditional communications and other communications, for example, device-to-device (D2D) communications, machine-to-machine (M2M) communications, machine type communications (MTC), vehicle-to-vehicle (V2V) communications, vehicle-to-everything (V2X) communications, and the like. These communication systems are applicable to the embodiments of the present disclosure.

The communication system according to the embodiments of the present disclosure is applicable to a carrier aggregation (CA) scenario, a dual connectivity (DC) scenario, and a standalone (SA) networking scenario.

The communication system according to the embodiments of the present disclosure is applicable to an unlicensed spectrum, which is also construed as a shared spectrum. Alternatively, the communication system according to the embodiments of the present disclosure is applicable to a licensed spectrum, which is also construed as a non-shared spectrum.

The embodiments of the present disclosure are applicable to the NTN system and a terrestrial network (TN) system.

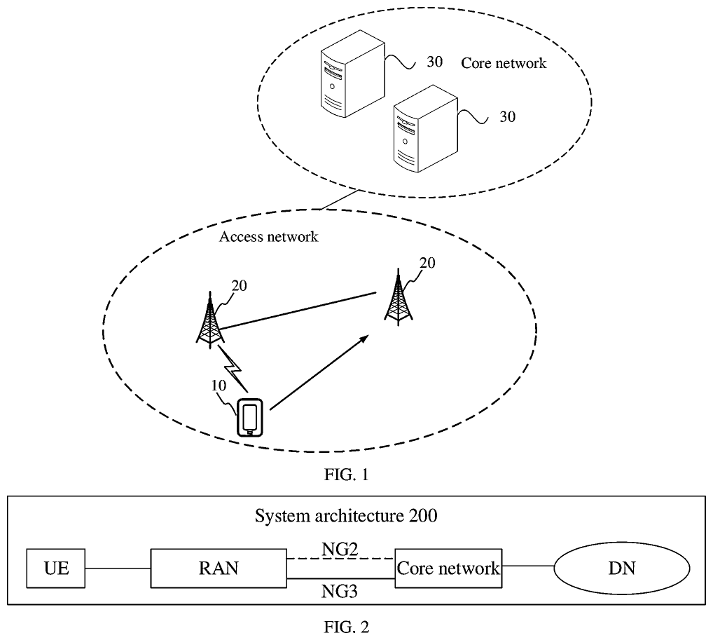

Referring to FIG. 1, a schematic diagram of a network architecture according to some embodiments of the present disclosure is illustrated. The network architecture includes: a terminal device 10, an access network device 20, and a core network element 30.

The terminal device 10 refers to a UE, an access terminal, a subscriber unit, a subscriber station, a mobile station, a mobile console, a remote station, a remote terminal, a mobile device, a wireless communication device, a user agent, a user device, or the like. In some embodiments, the terminal device 10 is a cellular phone, a cordless phone, a Session Initiation Protocol (SIP) phone, a wireless local loop (WLL) station, a personal digital assistant (PDA), a hand-held device with a wireless communication capability, a computing device or other processing devices connected to a wireless modem, an in-vehicle device, a wearable device, a terminal device in a 5^{th} generation system (5GS), a terminal device in an evolved public land mobile network (PLMN), or the like, which is not limited in the embodiments of the present disclosure. For convenience of description, the devices are collectively referred to as the terminal device. A plurality of terminal devices 10 are generally provided, and one or more terminal devices 10 are disposed in a cell managed by each access network device 20. In the embodiments of the present disclosure, the “terminal device” and the “UE” are exchangeable, and those skilled in the art understand the meanings.

The access network device 20 is a device deployed in the access network and is configured to provide a wireless communication function to the terminal device 10. The access network device 20 includes various forms of macro base stations, micro base stations, relay stations, access points, and the like. In systems adopting different wireless access technologies, devices with a function of the access network device having different names, for example, referred to as gNodeBs or gNBs in a 5G NR system. With the evolution of the communications technologies, the name of the “access network device” is changed. For convenience of description, in the embodiments of the present disclosure, the devices for providing the wireless communication function to the terminal device 10 are collectively referred to as the access network device. In some embodiments, the terminal device 10 communicates with the core network element 30 by the access network device 20. Illustratively, in an LTE system, the access network device 20 is an evolved universal terrestrial radio access network (EUTRAN) or one or more eNodeBs in the EUTRAN; and in a 5G NR system, the access network device 20 is a radio access network (RAN) or one or more gNBs in the RAN.

The core network element 30 is a network element deployed in the core network. The core network element 30 mainly functions to provide user connection, manage the user, and carry the traffic, and is used as a bearer network for providing an access to an external network. For example, the core network element of the 5G NR system includes an access and mobility management function (AMF), a user plane function (UPF), a session management function (SMF), and other network elements. In addition, the core network element is determined as a function entity, and one or more core network elements are deployed on a physical device.

In some embodiments, the access network device 20 and the core network element 30 communicate with each other using the air interface technology, for example, over an NG interface in the 5G NR system. The access network device 20 and the terminal device 10 communicate with each other using the air interface technology, for example, over a Uu interface.

The “5G NR system” in the embodiments of the present disclosure is also referred to as a 5G system or an NR system, and those skilled in the art understand the meanings. The technical solutions according to the embodiments of the present disclosure are applicable to the LTE system, the 5G NR system, an evolution system of the 5G NR system, and other communication systems, for example, narrow band Internet of things (NB-IoT), which is not limited in the present disclosure.

In the embodiments of the present disclosure, the access network device provides services for cells, and the terminal device communicates with the access network device over the transmission resources (for example, frequency-domain resources, or spectrum resources) in carriers used in the cells. The cell is a cell corresponding to the access network device (for example, a base station), and the cell belongs to a macro base station or a base station corresponding to a small cell. The small cell includes a metro cell, a micro cell, a pico cell, a femto cell, or the like. The small cells have the small coverage and low transmit power, and are suitable for providing high-rate data transmission services.

Referring to FIG. 2, a schematic diagram of a system architecture of a 5GS according to some embodiments of the present disclosure is illustrated. As illustrated in FIG. 2, the system architecture 200 includes the UE (i.e., the “terminal device” described above), the (R)AN, the core network, and a data network (DN). The UE, the (R)AN, and the core network are main elements of the architecture, and are logically arranged into two portions of a use side and a control side. The control side manages a mobile network, and the user side transmits traffic data. In the drawings, an NG2 reference point is configured between a (R)AN control side and a core network control side, an NG3 reference point is configured between a (R)AN user side and a core network user side, and an NG6 reference point is configured between the core network user side and the DN.

The UE is an access of interaction of a mobile user and the network, and is capable of providing essential computing capability and storing capability, displaying a traffic window to the user, and receiving operation input of the user. The UE establishes signal connection and data connection with the (R)AN using the next generation air interface technology, and hence transmits control signals and traffic data to the mobile network.

The (R)AN is similar to a base station in a conventional network, is deployed close to the UE, provides a network access function for authorized users within a specific area, and transmits user data based on levels of the users, requirements of traffics, and the like over transmission channels with different qualities. The (R)AN is capable of managing and reasonably using its own resources, providing access services for the UE on demand, and forwarding the control signals and the user data between the UE and the core network.

The core network maintains subscription data of the mobile network, manages network elements of the mobile network, and provides session management, mobility management, policy management, security authentication, and other functions to the UE. In the case that the UE is attached, the core network provides a network access authentication to the UE. In the case that the UE initiates a traffic request, the core network allocates network resources to the UE. In the case that the UE moves, the core network updates network resources for the UE. In the case that the UE is idle, the core network provides a quick resumption mechanism for the UE. In the case that the UE is detached, the core network releases the network resources for the UE. In the case that the UE has traffic data, the core network provides data routing functions to the UE, for example, a function of forwarding uplink data to the DN, or receiving UE downlink data from the DN, forwarding the UE downlink data to the (R)AN, and transmitting the UE downlink data to the UE.

The DN is a data network for providing the traffic service to the users. Generally, a client is configured in the UE, and a server end is configured in the data network. The data network is a private network (for example, a local area network), an external network not controlled by the carrier (for example, the Internet), or a proprietary network jointly deployed by the carriers (for example, for configuring Internet Protocol (IP) multimedia core network subsystem (IMS) services).

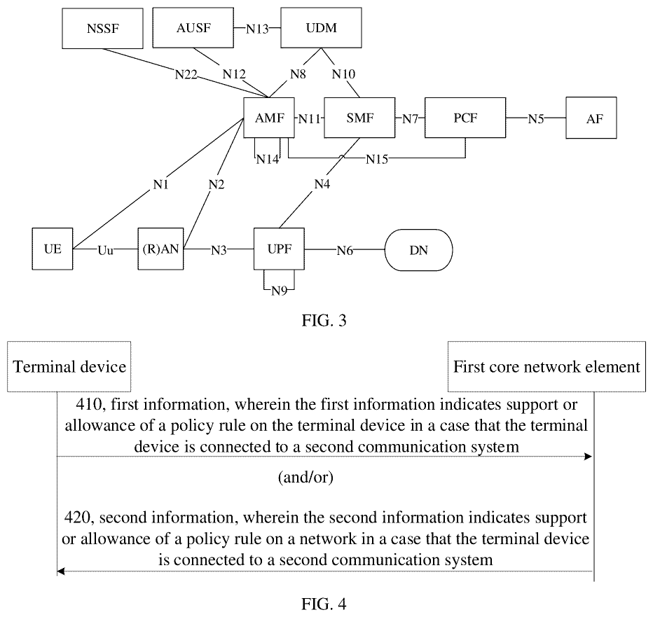

FIG. 3 is a detailed architecture determined based on FIG. 2. The core network user side includes a UPF, and the core network control side includes an authentication server function (AUSF), an AMF, an SMF, a network slice selection function (NSSF), a network exposure function (NEF), a network repository function (NRF), a unified data management (UDM), a PCF, and an application function (AF).

In the architecture illustrated in FIG. 3, the UE and the (R)AN achieve access stratum (AS) connection, AS message interaction and wireless data transmission over the Uu interface, and the UE and the AMF achieve non-access stratum (NAS) connection and NAS message interaction over the N1 interface. The AMF indicates the mobility management in the core network, and the SMF indicates the session management function in the core network. The AMF performs the mobility management on the UE, and forwards session management-related information between the UE and the SMF. The PCF indicates the policy management function in the core network, and develops policies related to the mobility management, the session management, charging, and the like on the UE. The UPF indicates the user side function in the core network, and achieves data transmission to the external network over the N6 interface and achieves data transmission to the (R)AN over the N3 interface.

It should be noted that names of the interfaces between various network elements in FIG. 2 and FIG. 3 are exemplary, and the names of the interfaces may be otherwise defined in specific implementations, which are not specifically limited in the embodiments of the present disclosure. The various network elements (for example, the SMF, the AF, the UPF, and the like) in FIG. 2 and FIG. 3 are also exemplarily named, and the names of the network elements do not limit the functions thereof. In the 5GS and other future networks, the network elements may have other names, which are not specifically limited in the embodiments of the present disclosure. For example, in the 6G network, some or all of the network elements follow the terms in the 5G in terms of naming, or have other names, or the like, which are unified herein and are not described hereinafter. In addition, it should be understood that names of messages (or signaling) transmitted between the network elements are also exemplary, and do not limit the functions of the messages.

In some embodiments, the network elements related to the policies are mainly the PCF, the AMF, the SMF, the RAN, and the UE. The SMF mainly enforces the policy related to the session, the AMF mainly enforces the policy related to the access and the UE policy, and the issue and update of the policy in the two network elements (the AMF and the SMF) are controlled by the PCF.

For the UE policy, information related to the UE policy, including content of the UE policy, UE policy identifier, and the like, is monitored by a container between the PCF and the UE. The container is transmitted to the AMF by the UE over the NAS message in an uplink direction, and is continuously transmitted (not sensed or modified) to the PCF by the AMF. Conversely, in a downlink direction, the PCF transmits the container to the AMF, and the AMF transmits the container to the UE over the NAS message.

Prior to description of the technical solutions according to the present disclosure, some background technical knowledge involved in the present disclosure is introduced. The following related arts may be determined as optional solutions and may be arbitrarily combined with the technical solutions according to the embodiments of the present disclosure, which shall fall within the scope of protection of the embodiments of the present disclosure. The embodiments of the present disclosure include at least some of the following content.

### 1. URSP

The URSP is a UE policy rule, determines a binding relationship between application data and a packet data unit (PDU) session, and further determines which PDU session needs to be established by the UE to meet the binding relationship.

The URSP includes a plurality of URSP rules, and each URSP rule includes a traffic descriptor and one or more RSDs.

Referring to Table 1, a list of traffic descriptors and corresponding route selection descriptors (RSDs) in the URSP rule is given. Referring to Table 2, detailed parameters in the RSD are listed.

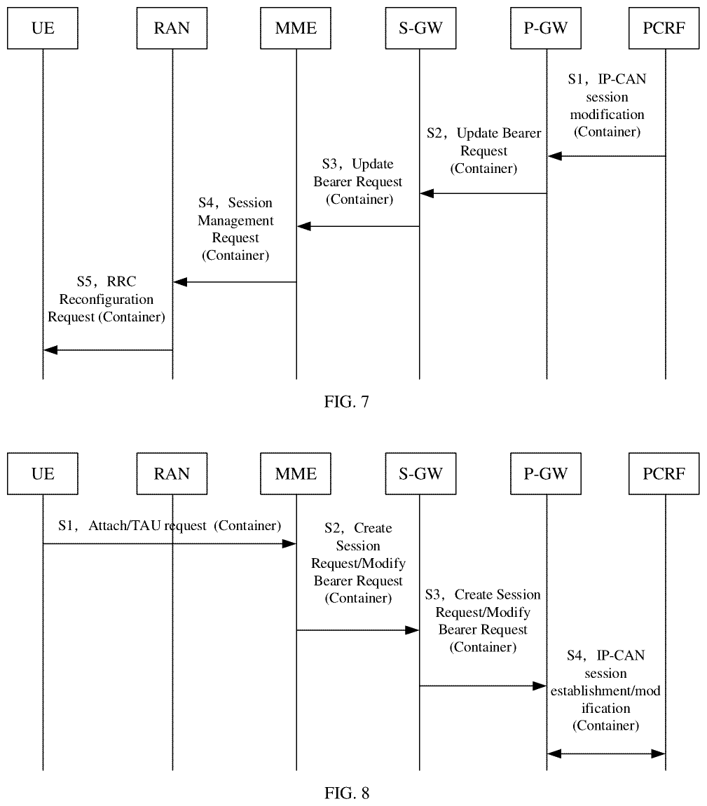

In some embodiments, the traffic descriptor in the URSP rule is configured to describe a specific traffic, for example, the application data stream illustrated in FIG. 7. For example, a micro-blog traffic is described by an IP@1-9 range, Internet Protocol (IP) multimedia subsystem (IMS) traffic is described by an IMS DNN. In some embodiments, a traffic descriptor includes one or more RSDs. In some embodiments, each of S-NSSAI and DNN in the RSD has one or more values, and other parameters in the RSD only have one value. Thus, each RSD corresponds to one or more components of parameters, each of the components of parameters is referred to as a set of features of a PDU session, and traffic data corresponding to the traffic descriptor is transmitted in a PDU session corresponding to a component of parameters of the RSD. In the case that the application data stream described by the traffic descriptor emerges, the UE selects a component of parameters based on a value of a component of the corresponding RSD to initiate a PDU session establishment request. In some embodiments, each time the UE initiates a PDU session establishment request, a set of session data parameters is carried in the request message, which is a component of parameter values in the RSD table of an URSP rule.

TABLE 1
List of traffic descriptors and corresponding RSDs in a URSP rule

| | | | PCF | |
|---|---|---|---|---|
| | | | permitted | |
| | | | to modify | |
| Information | | | in a UE | |
| name | Description | Category | context | Scope |
| Rule | Determines the order the URSP | Mandatory | Yes | UE |
| Precedence | rule is enforced in the UE. | (NOTE 1) | | context |
| Traffic | This part defines the Traffic | | | |
| descriptor | descriptor for the policy. | | | |
| Application | Application identifier(s). | Optional | Yes | UE |
| identifiers | | | | context |
| IP descriptors | IP 3 tuple(s) (destination IP | Optional | Yes | UE |
| | address or IPv6 network prefix, | | | context |
| | destination port number, | | | |
| | protocol ID of the protocol | | | |
| | above IP). | | | |
| Domain | Destination FQDN(s) | Optional | Yes | UE |
| descriptors | | | | context |
| Non-IP | Descriptor(s) for non-IP traffic. | Optional | Yes | UE |
| descriptors | | | | context |
| DNN | This is matched against the | Optional | Yes | UE |
| | DNN information provided by | | | context |
| | the application. | | | |
| Connection | This is matched against the | Optional | Yes | UE |
| Capabilities | information provided by a UE | | | context |
| | application when it requests a | | | |
| | network connection with certain | | | |
| | capabilities. | | | |
| List of Route | A list of Route Selection | Mandatory | | |
| Selection | Descriptors. The components of | | | |
| Descriptors | a Route Selection Descriptor are | | | |
| | described in table 2. | | | |

(NOTE 1):
Rules in a URSP shall have different precedence values.

TABLE 2
Parameters of RSDs

| | | | PCF | |
|---|---|---|---|---|
| | | | permitted | |
| Information | | | to modify | |
| name | Description | Category | in URSP | Scope |
| Route | Determines the order in | Mandatory | Yes | UE |
| Selection | which the Route Selection | (NOTE 1) | | context |
| Descriptor | Descriptors are to be applied. | | | |
| Precedence | | | | |
| Route | This part defines the route | Mandatory | | |
| selection | selection components | (NOTE 2) | | |
| components | | | | |
| SSC Mode | One single value of SSC mode. | Optional | Yes | UE |
| Selection | | | | context |
| Network Slice | Either a single value or a list | Optional | Yes | UE |
| Selection | of values of S-NSSAI(s). | | | context |
| DNN | Either a single value or a | Optional | Yes | UE |
| Selection | list of values of DNN(s). | | | context |
| Non-Seamless | Indicates if the traffic of the | Optional | Yes | UE |
| Offload | matching application is to | (NOTE 3) | | context |
| indication | be offloaded to non-3GPP | | | |
| | access outside of a PDU Session. | | | |
| Access Type | Indicates the preferred | Optional | Yes | UE |
| preference | Access Type (3GPP or non- | | | context |
| | 3GPP or Multi-Access) | | | |
| | when the UE establishes a | | | |
| | PDU Session for the | | | |
| | matching application. | | | |

(NOTE 1):
Every Route Selection Descriptors in the list shall have a different precedence value.
(NOTE 2):
At least one of the route selection components shall be present.
(NOTE 3):
If this indication is present in a Route Selection Descriptor, no other components shall be included in the Route Selection Descriptor.

### 2. Mapping of the URSP Rule

The URSP rule in the EPS used in the 4G network is mapped on the UE by the URSP rule received in the 5G network, as listed in Table 3 and Table 4. It can be seen that in the mapping procedure, both the traffic descriptor and the precedence parameter are the same across all URSP rules, whereas the parameter in the RSD varies, which is due to the fact that the RSD describes parameters of 5G PDU sessions and 4G public data network (PDN) connections, and the parameters for the 5G PDU sessions are almost entirely different from the parameters for the 4G PDN connections.

TABLE 3
Mapping list of traffic descriptor parameters

| Traffic | | |
|---|---|---|
| descriptor | | Mapped EPS parameter |
| parameter name | Description | description |
| Application | It consists of OSId and | OSId and OSAppId(s) |
| descriptors | OSAppId(s) | |
| IP descriptors | Destination IP 3 tuple(s) (IP | Destination IP 3 tuple(s) (IP |
| | address or IPv6 network | address or IPv6 network |
| | prefix, port number, protocol | prefix, port number, protocol |
| | ID of the protocol above IP) | ID of the protocol above IP) |
| Domain | Destination FQDN(s) or a | Destination FQDN(s) or a |
| descriptors | regular expression as a domain | regular expression as a |
| | name matching criteria | domain name matching |
| | | criteria |
| Non-IP | Descriptor(s) for destination | Descriptor(s) for destination |
| descriptors | information of non-IP traffic | information of non-IP traffic |
| DNN | This is matched against the | APN |
| | DNN information provided by | |
| | the application | |
| Connection | This is matched against the | This is matched against the |
| Capabilities | information provided by a UE | information provided by a |
| | application when it requests a | UE application when it |
| | network connection with | requests a network |
| | certain capabilities | connection with certain |
| | | capabilities |

TABLE 4
Mapping list of PSD parameters

| Route selection | | |
|---|---|---|
| descriptor | | Mapped EPS parameter |
| parameter name | Description | description |
| Route selection | Determines the order in | Determines the order in which |
| descriptor | which the route selection | the route selection descriptors |
| precedence | descriptors are to be applied | are to be applied |
| SSC Mode | One single value of SSC mode | Ignored in EPS if set to SSC |
| Selection | | mode 1 |
| | | Not applicable in EPS if set to |
| | | SSC mode 2 or 3 |
| Network Slice | Either a single value or a list | Not applicable in EPS |
| Selection | of values of S-NSSAI(s) | |
| DNN Selection | Either a single value or a list | Either a single value or a list of |
| | of values of DNN(s) | values of APN(s). |
| | | Not applicable in EPS if it |
| | | contains at least one LADN |
| | | DNN |
| PDU Session Type | One single value of PDU | PDN type: |
| Selection | Session Type | PDU session type |
| | | “Unstructured” is mapped |
| | | to PDN type “non-IP”. |
| | | PDU session type |
| | | “Ethernet” is mapped to |
| | | PDN type “Ethernet”, if |
| | | supported by the UE. |
| | | Otherwise PDU session |
| | | type “Ethernet” is mapped |
| | | to PDN type “non-IP” |
| Non-Seamless | Indicates if the traffic of the | Indicates if the traffic of the |
| Offload | matching application is to be | matching application is to be |
| indication | offloaded to non-3GPP access | offloaded to non-3GPP access |
| | outside of a PDU session | outside of a PDN connection |
| Access Type | Indicates the preferred Access | Preferred Access Type (3GPP |
| preference | Type (3GPP or non-3GPP) | or non-3GPP) |
| | when the UE establishes a | |
| | PDU Session for the | |
| | matching application | |
| Multi-Access | Indicates that the PDU | Not applicable in EPS |
| preference | session should be established | |
| | as a multi-access PDU | |
| | session, using both 3GPP | |
| | access and non-3GPP access. | |
| Time window | The time window when the | Not applicable in EPS |
| | matching traffic is allowed. | |
| Location criteria | The UE location where the | Not applicable in EPS |
| | matching traffic is allowed. | |

Currently, the URSP is transmitted only in the case that the UE is in the 5GS. For behavior consistence of the UE in the 5GS and the EPS, the URSP rule used in the EPS is transmitted to the UE, and the negotiation of the URSP configuration capability of the 4G network is considered. Thus, further researches are required on provision and use of the policy rules currently. The technical solutions according to the present disclosure are described in conjunction with some embodiments hereinafter.

Referring to FIG. 4, a flowchart of a method for wireless communication according to some embodiments of the present disclosure is illustrated. The method is applicable to the network architecture illustrated in FIG. 1 to FIG. 3. The method includes at least one of S410 and S420.

In S410, a terminal device transmits first information to a first core network element, wherein the first information indicates support or allowance of a policy rule on the terminal device in a case that the terminal device is connected to a second communication system. Correspondingly, the first core network element receives the first information from the terminal device.

In S420, the first core network element transmits second information to the terminal deice, wherein the second information indicates support or allowance of the policy rule on a network in a case that the terminal device is connected to the second communication system. Correspondingly, the terminal deice receives the second information from the first core network element.

In S410 and S420, the first core network element is a core network element in a first communication system, and the first communication system is different from the second communication system.

In some embodiments, the first communication system being different from the second communication system means that the first communication system and the second communication system are two different communication systems. For example, the first communication system and the second communication system have different system architectures. For example, the first communication system and the second communication system have different core network architectures. For example, the first communication system and the second communication system belong to different evolution versions.

In some embodiments, the first communication system is an EPS, and the second communication system is a 5GS. In the case that the first communication system is an EPS, the first core network element is an AMF or a PCF.

In some embodiments, the first communication system is a 5GS, and the second communication system is an EPS. In the case that the first communication system is a 5GS, the first core network element is a mobility management entity (MME) or a PCRF.

The EPS is also construed as an LTE system, an evolved universal terrestrial radio access (E-UTRA) system, a 4G system, or others, and those skilled in the art understand the meanings. The 5GS is also construed as a 5G NR system, a 5G system, an NR system, or others, and those skilled in the art understand the meanings. The core network in the EPS is also construed as an evolved packet core network (EPC), and the core network in the 5GS is also construed as a 5G core network (5GC).

In some embodiments, by taking the first communication system being an NR system (or 5GS) and the second communication system being an LTE system (or EPS) as an example, the first core network element is a core network element in the 5GS, the terminal device transmits the first information to the core network element in the 5GS, and/or the core network element in the 5GS transmits the second information to the terminal device.

In some embodiments, the first core network element is a core network element in the first communication system for managing the policy rule. For example, in the case that the first communication system is an NR system (or 5GS), the first core network element is a PCF. For example, in the case that the first communication system is an LTE system (or EPS), the first core network element is a PCRF.

In some embodiments, the first communication system and the second communication system belong to a same operator.

In some embodiments, the first communication system and the second communication system belong to a same PLMN. For example, a PLMN ID of the first communication system is the same as a PLMN ID of the second communication system. Alternatively, the first communication system and the second communication system belong to different PLMNs. For example, a PLMN ID of the first communication system is different from a PLMN ID of the second communication system.

In some embodiments, a coverage range of the first communication system is the same as or different from a coverage range of the second communication system. For example, assuming that the first communication system is an NR system, and the second communication system is an LTE system, then a coverage range of the NR system is generally smaller than the coverage range of the LTE system. For example, for an NR system (5G network) and an LTE system (4G network) in the same PLMN, a coverage range of the LTE system includes and is larger than the coverage range of the NR system, and thus the terminal device is likely to move from the NR system (the 5G network) to the LTE system (the 4G network).

In some embodiments, the first information indicates at least one of:
information indicating whether the terminal device supports configuring the policy rule in the second communication system;
information indicating whether the terminal device supports using the policy rule in the second communication system; or
information indicating whether the terminal device supports mapping of policy rules between the first communication system and the second communication system.

Illustratively, by taking the first communication system being an NR system (or 5GS) and the second communication system being an LTE system (or EPS) as an example, the first information indicates at least one of: information indicating whether the terminal device supports configuring the policy rule in the EPS; information indicating whether the terminal device supports using the policy rule in the EPS; or information indicating whether the terminal device supports mapping of policy rules between the 5GS and the EPS.

In some embodiments, the second information indicates at least one of:
information indicating whether the network supports transmitting the policy rule to the terminal device in the case that the terminal device is connected to the second communication system; or
information indicating whether the network allows the terminal device to use the policy rule in the second communication system.

Illustratively, by taking the first communication system being an NR system (or 5GS) and the second communication system being an LTE system (or EPS) as an example, the second information indicates at least one of: information indicating whether the network supports transmitting the policy rule to the terminal device in the case that the terminal device is connected to the EPS; or information indicating whether the network allows the terminal device to use the policy rule in the EPS.

Illustratively, the terminal device being connected to the second communication system means that the terminal device is initially connected to the second communication system, or the terminal device moves from the first communication system to the second communication system, which is not limited in the embodiments of the present disclosure. For example, assuming that the first communication system is an NR system (or 5GS), the second communication system is an LTE system (or EPS), and the 5G network and the 4G network are present in the same PLMN, the terminal device may move from the 5G network to the 4G network.

It should be noted that there is no necessary connection between the first information and the second information. For example, in the case that the second information is transmitted whereas the first information is not transmitted, the first core network element transmits the second information to the terminal device without receiving the first information. Alternatively, in the case that the first information is transmitted whereas the second information is not transmitted, the terminal device transmits the first information to the first core network element, but the first core network element does not or does not need to transmit the second information to the terminal device. Alternatively, in the case that the first information and the second information are both transmitted, transmission opportunities for the first information and the second information are not limited in the present disclosure. In some embodiments, the first information is transmitted prior to transmission of the second information. For example, the terminal device transmits the first information to the first core network element, and then the first core network element transmits the second information to the terminal device. In some embodiments, the first information is transmitted subsequent to transmission of the second information, or the first information and the second information are transmitted simultaneously, which is not limited in the embodiments of the present disclosure.

In some embodiments, the first information is carried in a registration request message or an attach request message. For example, the terminal device transmits a registration request message or the attach request message to the first core network element, wherein the registration request message or the attach request message includes the first information. In some embodiments, the registration request message or the attach request message contains a first container, wherein the first container contains the first information. That is, the first information is carried in a container, and is interacted between the terminal device and the first core network element. In addition, in the case that another immediate network element is configured between the terminal device and the first core network element, and the first information needs to be transmitted over the immediate network element, the immediate network element transparently transmits the first information.

In some embodiments, the second information is carried in a reply message corresponding to the registration request message or the attach request message. For example, the first core network element transmits a reply message corresponding to the registration request message or the attach request message to the terminal device, wherein the reply message includes the second information. In some embodiments, the reply message contains a second container, and the second container contains the second information. That is, the second information is carried in a container, and is interacted between the first core network element and the terminal device. In addition, in the case that another immediate network element is configured between the first core network element and the terminal device, and the second information needs to be transmitted over the immediate network element, the immediate network element transparently transmits the second information.

In some embodiments, the registration request message includes but is not limited to at least on of: an initial registration request message, a periodic registration request message, or a location-updated registration request message. The initial registration request message is a registration request message transmitted by the terminal device to the core network device in response to initial power on of the terminal device. The periodic registration request message is a registration request message periodically transmitted by the terminal device to the core network device. The address-updated registration request message is a registration request message transmitted by the terminal device to the core network device in response to an address update of the terminal device.

In some embodiments, the policy rule includes but is not limited to at least one of: a URSP rule, a vehicle-to-everything policy (V2XP) rule, a proximity service policy (ProSeP) rule, an ANDSP rule, or an access traffic steering, switching and splitting (ATSSS) policy rule.

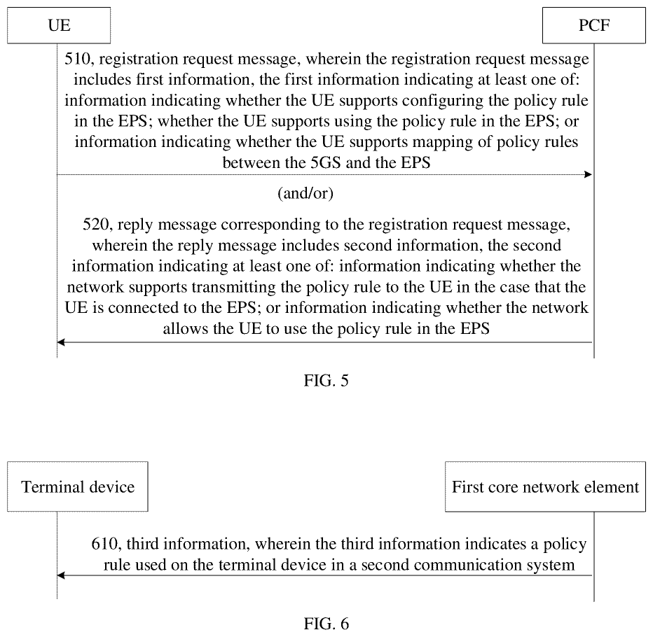

Illustratively, as illustrated in FIG. 5, by taking the first communication system being an NR system (or 5GS) and the second communication system being an LTE system (or EPS) as an example, the first core network element is a PCF in the 5GS, and the method includes S510 and/or S520.

In S510, a UE transmits a registration request message to the PCF, wherein the registration request message includes first information. The first information indicates at least one of: information indicating whether the UE supports configuring the policy rule in the EPS; whether the UE supports using the policy rule in the EPS; or information indicating whether the UE supports mapping of policy rules between the 5GS and the EPS.

In S520, the PCF transmits a reply message corresponding to the registration request message to the UE, wherein the reply message includes second information. The second information indicates at least one of: information indicating whether the network supports transmitting the policy rule to the UE in the case that the UE is connected to the EPS; or information indicating whether the network allows the UE to use the policy rule in the EPS.

It should be noted that one of S510 and S520 is performed, or S510 and S520 are both performed, which is not limited in the present disclosure.

Behaviors of the terminal device and/or the network subsequent to the transmission of the first information and/or the second information are illustrated hereinafter by taking the policy rule being an URSP rule as an example.

In some embodiments, in the case that the terminal device receives the second information from the network, and the second information indicates that the 4G network does not support/allow to configure the URSP rule, the terminal device maps the EPS URSP using the 5GS URSP received in the 5G network for the terminal device to use in the EPS.

In some embodiments, in the case that the terminal device transmits the first information, and the first information indicates that the terminal device does not support mapping between the 5GS URSP and the EPS URSP, the network transmits the second information to indicate support in configuring the URSP in the 4G network.

In some embodiments, the terminal device transmits the first information to indicate that the terminal device supports configuring the URSP in the 4G network, and thus the second information from the network indicates that the network supports configuring the URSP in the 4G network.

In some embodiments, in the case that the terminal device transmits the first information to indicate that the terminal device does not support configuring the URSP in the 4G network, the network transmits the 5GS URSP and the EPS URSP to the terminal device, and/or the terminal device self-maps the EPS URSP based on the 5GS URSP in the case that the network transmits the 5GS URSP.

In some embodiments, in the case that the terminal device transmits the first information to indicate that the terminal device supports mapping between the 5GS URSP and the EPS URSP, the network transmits the 5GS URSP, and the terminal device maps the EPS URSP based on the 5GS URSP.

It should be noted that behaviors of the terminal device and/or network are illustrated in the above descriptions by taking the URSP rule as an example, and the technical solutions according to the present disclosure are also applicable to negotiation of other policy rules. In addition, behaviors of the terminal device and/or network in the above embodiments are only exemplary and explanatory. The present disclosure is not intended to limit the terminal device and/or network to these behaviors, and other behaviors of the terminal device and/or network are also within the scope of protection of the present disclosure.

In the technical solutions according to the embodiments of the present disclosure, based on information interaction between the terminal device and the core network element in the first communication system, the terminal device transmits (or receives) support or allowance of the policy rule on the terminal device (or the network) in the first communication system in the case that the terminal device is connected to the second communication system, such that negotiation of a policy rule configuration capability of the second communication system is achieved in the first communication system, and the policy rule in the second communication system is further acquired in the first communication system in the case that the terminal device or the network does not support configuring one or more policy rules in the second communication system, which helps to enhance communication reliability.

By taking the first communication system being an NR system (or 5GS) and the second communication system being an LTE system (or EPS) as an example, as the UE and the 4G network need to be additionally enhanced in the case that the URSP is configured in the EPS, considering that the 4G network or the UE may not support the URSP configuration capability in actual deployment, the UE needs to negotiate with the network (mainly refers to the 5G network) to acquire the EPS URSP in the 5G network in the case that the UE or the network does not support configuring the URSP in the 4G network.

Processing methods of the terminal device and the first core network element for different cases indicated by the first information are illustrated hereinafter.

In some embodiments, in the case that the first information indicates that the terminal device does not support configuring the policy rule in the second communication system, the first core network element transmits the policy rule used in the second communication system to the terminal device; or, the first core network element transmits the policy rule used in the first communication system to the terminal device, and the terminal device determines the policy rule used in the second communication system based on the policy rule used in the first communication system.

For example, in the case that the terminal device does not support configuring the policy rule in the second communication system, the first core network element directly transmits the policy rule used in the second communication system to the terminal device, such that the policy rule does not need to be configured in the second communication system; or, the terminal device deduces/maps/determines the policy rule used in the second communication system based on the policy rule used in the first communication system from the first core network element.

In some embodiments, in the case that the first information indicates that the terminal device does not support configuring the policy rule in the second communication system, the first core network element transmits the policy rule used in the first communication system and the policy rule used in the second communication system to the terminal device; or, in the case that the first information indicates that the terminal device does not support configuring the policy rule in the second communication system, the first core network element transmits the policy rule used in the second communication system to the terminal device, such that the terminal device deduces/maps/determines the policy rule used in the first communication system based on the policy rule used in the second communication system.

In some embodiments, in the case that the first information indicates that the terminal device supports configuring the policy rule in the second communication system, the first core network element transmits the policy rule used in the first communication system to the terminal device; and/or, the second core network element transmits the policy rule used in the second communication system to the terminal device, and the second core network element is a core network element in the second communication system.

For example, in the case that the first information indicates that the terminal device supports configuring the policy rule in the second communication system, the first core network element only transmits the policy rule used in the first communication system to the terminal device, but does not transmit the policy rule used in the second communication system to the terminal device. For example, the policy rule used in the second communication system is transmitted to the second communication system by the second core network element.

In some embodiments, in the case that the first information indicates that the terminal device supports configuring the policy rule in the second communication system, the first core network element transmits the policy rule used in the second communication system to the terminal device, or, the first core network element transmits the policy rule used in the first communication system and the policy rule used in the second communication system to the terminal device.

In some embodiments, in the case that the first information indicates that the terminal device does not support using the policy rule in the second communication system, the first core network element transmits the policy rule used in the first communication system to the terminal device. In some embodiments, the first core network element does not transmit the policy rule used in the second communication system to the terminal device.

In some embodiments, in the case that the first information indicates that the terminal device does not support using the policy rule in the second communication system, the first core network element transmits the policy rule used in the second communication system to the terminal device, and the terminal device deduces/maps/determines the policy rule used in the first communication system based on the policy rule used in the second communication system.

In some embodiments, in the case that the first information indicates that the terminal device supports using the policy rule in the second communication system, the first core network element transmits the policy rule used in the second communication system to the terminal device; or, the first core network element transmits the policy rule used in the first communication system to the terminal device, and the terminal device deduces/maps/determines the policy rule used in the second communication system based on the policy rule used in the first communication system.

For example, in the case that the first information indicates that the terminal device supports using the policy rule in the second communication system, the first core network element directly provides the policy rule used in the second communication system to the terminal device. In some embodiments, the first core network element provides the policy rule used in the first communication system. In some embodiments, in the case that the first information indicates that the terminal device supports using the policy rule in the second communication system, the first core network element only provides the policy rule used in the first communication system to the terminal device, and the terminal device self-deduces/self-maps/self-determines the policy rule used in the second communication system based on the policy rule used in the first communication system.

In some embodiments, in the case that the first information indicates that the terminal device supports using the policy rule in the second communication system, the first core network element transmits the policy rule used in the first communication system and the policy rule used in the second communication system to the terminal device; or, the first core network element transmits the policy rule used in the second communication system to the terminal device, and the terminal device deduces/maps/determines the policy rule used in the first communication system based on the policy rule used in the second communication system.

In some embodiments, in the case that the first information indicates that the terminal device supports mapping of the policy rules between the first communication system and the second communication system, the first core network element transmits the policy rule used in the first communication system to the terminal device, and the terminal device deduces/maps/determines the policy rule used in the second communication system based on the policy rule used in the first communication system; or, the first core network element transmits the policy rule used in the second communication system to the terminal device, and the terminal device deduces/maps/determines the policy rule used in the first communication system based on the policy rule used in the second communication system; or, the first core network element transmits the policy rule used in the first communication system and the policy rule used in the second communication system to the terminal device.

For example, in the case that the first information indicates that the terminal device supports mapping of the policy rules between the first communication system and the second communication system, the first core network element only provides the policy rule used in one communication system to the terminal device, and the terminal device self-deduces/self-maps/self-determines the policy rule used in the other communication system based on the policy rule used in the one communication system.

In some embodiments, in the case that the first information indicates that the terminal device does not support mapping of the policy rules between the first communication system and the second communication system, the first core network element transmits the policy rule used in the first communication system and/or the policy rule used in the second communication system to the terminal device.

For example, in the case that the first information indicates that the terminal device does not support mapping of the policy rules between the first communication system and the second communication system, the first core network element transmits the policy rule used in the first communication system and the policy rule used in the second communication system to the terminal device, such that the terminal device acquires the policy rules used in different communication systems in the case that the terminal device does not have a rule mapping capability in different systems.

Processing methods of the terminal device and the first core network element for different cases indicated by the second information are illustrated hereinafter.

In some embodiments, in the case that the second information indicates that the network does not support transmitting the policy rule to the terminal device in the case that the terminal device is connected to the second communication system, the first core network element transmits the policy rule used in the second communication system to the terminal device; or, the first core network element transmits the policy rule used in the first communication system to the terminal device, and the terminal device deduces/maps/determines the policy rule used in the second communication system based on the policy rule used in the first communication system.

For example, in the case that the second information indicates that the network does not support transmitting the policy rule to the terminal device in the case that the terminal device is connected to the second communication system, the first core network element transmits the policy rule used in the second communication system to the terminal device, such that the terminal device acquires the policy rule used in the second communication system in the case that the terminal device is connected to the first communication system, and the policy rule is not configured in the second communication system; or, the terminal device deduces/maps/determines the policy rule used in the second communication system based on the policy rule used in the first communication system from the first core network element.

In some embodiments, in the case that the second information indicates that the network does not support transmitting the policy rule to the terminal device in the case that the terminal device is connected to the second communication system, the first core network element transmits the policy rule used in the first communication system and the policy rule used in the second communication system to the terminal device; or, the first core network element transmits the policy rule used in the second communication system to the terminal device, and the terminal device deduces/maps/determines the policy rule used in the first communication system based on the policy rule used in the second communication system.

In some embodiments, in the case that the second information indicates that the network supports transmitting the policy rule to the terminal device in the case that the terminal device is connected to the second communication system, the first core network element transmits the policy rule used in the first communication system to the terminal device; and/or, the second core network element transmits the policy rule used in the second communication system to the terminal device, and the second core network element is a core network element in the second communication system.

For example, in the case that the second information indicates that the network supports transmitting the policy rule to the terminal device in the case that the terminal device is connected to the second communication system, the first core network element only transmits the policy rule used in the first communication system to the terminal device and does not transmit the policy rule used in the second communication system. For example, the policy rule used in the second communication system is transmitted to the terminal device by the second core network element.

In some embodiments, in the case that the second information indicates that the network supports transmitting the policy rule to the terminal device in the case that the terminal device is connected to the second communication system, the first core network element transmits the policy rule used in the second communication system to the terminal device; or, the first core network element transmits the policy rule used in the first communication system and the policy rule used in the second communication system to the terminal device.

In some embodiments, in the case that the second information indicates that the network allows the terminal device to use the policy rule in the second communication system, the first core network element transmits the policy rule used in the first communication system and/or the policy rule used in the second communication system to the terminal device. In some embodiments, in the case that the first core network element transmits the policy rule used in the first communication system, the terminal device deduces/maps/determines the policy rule used in the second communication system based on the policy rule used in the first communication system. In some embodiments, in the case that the first core network element transmits the policy rule used in the second communication system, the terminal device deduces/maps/determines the policy rule used in the first communication system based on the policy rule used in the second communication system.

In some embodiments, in the case that the second information indicates that the network does not allow the terminal device to use the policy rule in the second communication system, the first core network element transmits the policy rule used in the first communication system to the terminal device. In some embodiments, the first core network element does not transmit the policy rule used in the second communication system to the terminal device.

It should be noted that in the above embodiments, for detailed implementations of deduction/mapping/determination of the policy rule used in the first communication system by the terminal device based on the policy rule used in the second communication system or detailed implementations of deduction/mapping/determination of the policy rule used in the second communication system by the terminal device based on the policy rule used in the first communication system, reference may be made to descriptions in the following embodiments.

It should be further noted that in the above embodiments, transmission of the policy rule from the first core network element to the terminal device may be construed as transmission of information from the first core network element to the terminal device, and the information indicates the policy rule used on the terminal device. In addition, the information indicating the policy rule used on the terminal device may be construed as that the information includes the policy rule used on the terminal device or that the information includes identification information of the policy rule used on the terminal device, and the terminal device acquires the corresponding policy rule from other sources based on the identification information. For example, the first core network element transmits third information to the terminal device, and the third information indicates the policy rule used on the terminal device in the second communication system. For example, the first core network element transmits third information to the terminal device, and the third information indicates the policy rule used on the terminal device in the second communication system and the policy rule used on the terminal device in the first communication system. For example, the first core network element transmits fourth information to the terminal device, and the fourth information indicates the policy rule used on the terminal device in the first communication system. For details of the third information and the fourth information, reference may be made to descriptions in the following embodiments, which are not described herein any further.

It should be further noted that the above embodiments mainly illustrate the processing methods of the terminal device and the first core network element in the case that the first information indicates a specific situation or the second information indicates a specific situation. It should be understood that the first information may indicate several situations. For example, the first information indicates at least one of: information indicating whether the terminal device supports configuring the policy rule in the second communication system; information indicating whether the terminal device supports using the policy rule in the second communication system; or information indicating whether the terminal device supports mapping of policy rules between the first communication system and the second communication system. The second information may also indicate several situations. For example, the second information indicates at least one of: information indicating whether the network supports transmitting the policy rule to the terminal device in the case that the terminal device is connected to the second communication system; or information indicating whether the network allows the terminal device to use the policy rule in the second communication system. In addition, only the first information but no second information is transmitted, only the second information but no first information is transmitted, or the first information and the second information are both transmitted. On the basis of the descriptions in the above embodiments, those skilled in the art may determine corresponding processing methods of the terminal device and the first core network element by combining different case combinations and information combinations, which shall fall within the scope of protection of the present disclosure.

Referring to FIG. 6, a flowchart of a method for wireless communication according to some embodiments of the present disclosure is illustrated. The method is applicable to the network architecture illustrated in FIG. 1 to FIG. 3. The method includes S610.

In S610, a first core network element transmits third information to a terminal device, wherein the first core network element is a core network element in a first communication system, the third information indicates a policy rule used on the terminal device in a second communication system, and the first communication system is different from the second communication system.

Correspondingly, the terminal device receives the third information from the first core network element.

In some embodiments, the third information indicating the policy rule used on the terminal device in the second communication system may be construed as that the third information includes the policy rule used on the terminal device in the second communication system or that the third information includes identification information of the policy rule used on the terminal device in the second communication system, and the terminal device acquires the corresponding policy rule from other sources based on the identification information.

In some embodiments, the first communication system being different from the second communication system means that the first communication system and the second communication system are two different communication systems. For example, the first communication system and the second communication system have different system architectures. For example, the first communication system and the second communication system have different core network architectures. For example, the first communication system and the second communication system belong to different evolution versions.

In some embodiments, the first communication system is an EPS, and the second communication system is a 5GS. In the case that the first communication system is an EPS, the first core network element is an AMF or a PCF.

In some embodiments, the first communication system is a 5GS, and the second communication system is an EPS. In the case that the first communication system is a 5GS, the first core network element is an MME or a PCRF.

The EPS is also construed as an LTE system, an E-UTRA system, a 4G system, or others, and those skilled in the art understand the meanings. The 5GS is also construed as a 5G NR system, a 5G system, an NR system, or others, and those skilled in the art understand the meanings. The core network in the EPS is also construed as an EPC, and the core network in the 5GS is also construed as a 5GC.

In some embodiments, the first core network element is a core network element in the first communication system for managing the policy rule. For example, in the case that the first communication system is an NR system (or 5GS), the first core network element is a PCF. For example, in the case that the first communication system is an LTE system (or EPS), the first core network element is a PCRF.

In some embodiments, by taking the first communication system being an LTE system (or EPS) and the second communication system being an NR system (or 5GS) as an example, the first core network element is a core network element in the EPS, for example, a PCRF, and the PCRF transmits the third information to the terminal device. The third information indicates the policy rule used on the terminal device in the 5GS.

In some embodiments, by taking the first communication system being an NR system (or 5GS) and the second communication system being an LTE system (or EPS) as an example, the first core network element is a core network element in the 5GS, for example, a PCF, and the PCF transmits the third information to the terminal device. The third information indicates the policy rule used on the terminal device in the EPS.

In some embodiments, the first communication system and the second communication system belong to a same operator.

In some embodiments, the first communication system and the second communication system belong to a same PLMN. For example, a PLMN ID of the first communication system is the same as a PLMN ID of the second communication system. Alternatively, the first communication system and the second communication system belong to different PLMNs. For example, a PLMN ID of the first communication system is different from a PLMN ID of the second communication system.

In some embodiments, a coverage range of the first communication system and a coverage range of the second communication system are the same or different. For example, assuming that the first communication system is an NR system, and the second communication system is an LTE system, then a coverage range of the NR system is generally smaller than a coverage range of the LTE system. For example, for an NR system (5G network) and an LTE system (4G network) in the same PLMN, a coverage range of the LTE system includes and is larger than a coverage range of the NR system, and thus the terminal device is likely to move from the NR system (5G network) to the LTE system (4G network).

In some embodiments, upon receiving the third information, the terminal device determines, based on the third information, the policy rule used in the second communication system. In some embodiments, the terminal device determines the policy rule used in the first communication system based on the policy rule used in the second communication system. For example, the terminal device acquires the policy rule used in the first communication system by determining, based on a mapping relationship of the policy rules in the second communication system and the first communication system, a policy rule corresponding to the policy rule used in the second communication system.

Illustratively, the policy rule includes a URSP, and the terminal device determines, based on the mapping relationship of the policy rules in the second communication system and the first communication system, an RSD used in the first communication system and corresponding to an RSD used in the second communication system with a same traffic descriptor.

In some embodiments, the third information indicates the policy rule used on the terminal device in the second communication system, and further indicates a policy rule used on the terminal device in the first communication system. That is, the third information indicates the policy rule used on the terminal device in the first communication system and the policy rule used on the terminal device in the second communication system. In this case, the terminal device directly acquires, based on the third information, the policy rule used in the first communication system and the policy rule used in the second communication system, but does not need to map the policy rule used in the first communication system based on the policy rule used in the second communication system.

In some embodiments, the third information further indicating the policy rule used on the terminal device in the first communication system may be construed as that the third information includes the policy rule used on the terminal device in the first communication system or that the third information includes identification information of the policy rule used on the terminal device in the first communication system. The terminal device acquires the corresponding policy rule from other sources based on the identification information.

Illustratively, the policy rule includes a URSP. The first core network element transmits the third information to the terminal device, and the third information includes an RSD used in the second communication system and an RSD used in the first communication system with a same traffic descriptor. In some embodiments, names of parameters of the traffic descriptors are the same or different. In the case that the names are different, the parameters of the two RSD are equivalent (that is, values are equal). For example, although names of the DNN in the NR system and the APN in the LTE system with the same traffic descriptor are different, the parameters are equivalent or the same.

In some embodiments, the traffic descriptors are also mappable. For example, the traffic descriptor in the first communication system is mapped based on the traffic descriptor in the second communication system, and the terminal device uses the traffic descriptor in the second communication system in the case that the terminal device is in the second communication system and uses the traffic descriptor in the first communication system in the case that the terminal device is in in the first communication system. By taking the second communication system being a 5GS and the first communication system being an EPS as an example, the terminal device maps the traffic descriptor in the EPS based on the traffic descriptor in the 5GS, and the terminal device uses the traffic descriptor in the 5GS in the case that the terminal device accesses the 5G network and uses the traffic descriptor in the EPS in the case that the terminal device accesses the 4G network.

In some embodiments, the traffic descriptor in the first communication system and the RSD in the traffic descriptor are mapped based on the traffic descriptor in the second communication system and the RSD in the traffic descriptor, and the terminal device uses the traffic descriptor in the second communication system and the RSD in the traffic descriptor in the case that the terminal device is in the second communication system and uses the traffic descriptor in the first communication system and the RSD in the traffic descriptor in the case that the terminal device is in the first communication system. By taking the second communication system being a 5GS and the first communication system being an EPS as an example, the terminal device maps the traffic descriptor in the EPS and the RSD in the traffic descriptor based on the traffic descriptor in the 5GS and the RSD in the traffic descriptor, and the terminal device uses the traffic descriptor in the 5GS and the RSD in the traffic descriptor in the case that the terminal device accesses the 5G network and uses the traffic descriptor in the EPS and the RSD in the traffic descriptor in the case that the terminal device accesses the 4G network.

In some embodiments, the third information is carried in a container for transmission. For example, an immediate node between the first core network element and the terminal device transmits the third information carried in the container. The terminal device reads the third information carried in the container from a received message to acquire the policy rule provided by the network to the terminal device.

In some embodiments, the policy rule includes, but is not limited to, a URSP rule, a V2XP rule, a ProSeP rule, an ANDSP rule, or an ATSSS policy rule.

In some embodiments, the third information is transmitted based on the P-GW initiated bearer modification procedure. In some embodiments, by taking the first communication system being an LTE system (or EPS) and the second communication system being an NR system (or 5GS) as an example, the first core network element is a PCRF in the EPS, and the PCRF transmits the third information based on the P-GW initiated bearer modification procedure. The policy rule used on the terminal device in the 5GS is indicated by the third information.

Referring to FIG. 7, a schematic diagram of transmission of third information by a PCRF based on a P-GW initiated bearer modification procedure is illustrated. The flowchart includes the following procedures.
S1, a PCRF initiates IP-CAN session modification;
S2, a P-GW transmits an update bearer request to an S-GW;
S3, the S-GW transmits the update bearer request to the MME;
S4, the MME transmits a session management request to the RAN; and
S5, the RAN transmits an RRC reconfiguration request to a UE.

In some embodiments, the third information is carried in the above IP-CAN session modification, the update bearer request, the session management request, and the RRC reconfiguration request. For example, the third information is carried in the container for transmission, and the immediate node (including the P-GW, the S-GW, the MME, and the RAN illustrated in FIG. 7 (or the access network device or the station)) between the PCRF and the UE transmits the third information carried in the container. The terminal device reads the third information carried in the container from the RRC reconfiguration request to acquire the policy rule used on the terminal device in the 5GS.

In some embodiments, upon receiving the fourth information from the terminal device, the first core network element transmits the third information to the terminal device. In some embodiments, the fourth information is configured to provide reference to the first core network element on whether to transmit the third information to the terminal device. For example, the first core network element determines, based on the fourth information (or in combination with the fourth information and other pieces of information), whether it is necessary to provide the policy rule used in the second communication system to the terminal device. In the case that it is necessary to provide the policy rule used in the second communication system to the terminal device, the first core network element transmits the third information to the terminal device, and the policy rule used on the terminal device in the second communication system is indicated by the third information. In the case that it is unnecessary to provide the policy rule used in the second communication system to the terminal device, the first core network element does not transmit the third information to the terminal device. In some embodiments, the fourth information is carried in the container.

In some embodiments, by taking the first communication system being an LTE system (or EPS) and the second communication system being an NR system (or 5GS) as an example, in the case that the terminal device is in the EPS (which is initially registered or moves from the 5GS to the EPS), the fourth information is transmitted to the PCRF based on an attach (or connection) procedure or a tracking area update (TAU) procedure. Referring to FIG. 8, a schematic diagram of transmission of fourth information by a UE based on an attach or TAU procedure is illustrated. The flowchart includes the following procedures.
S1, attach/TAU request;
S2, create session request/modify bearer request;
S3, create session request/modify bearer request;
S4, IP-CAN session establishment/modification.

In some embodiments, the fourth information is carried in the attach/TAU request, the create session request/modify bearer request, and the IP-CAN session establishment/modification. For example, the fourth information is carried in the container for transmission, and the immediate node (including the MME, the S-GW, and the P-GW illustrated in FIG. 8) between the UE and the PCRF transmits the fourth information carried in the container. The PCRF reads the fourth information carried in the container from the request to determine, based on the fourth information (or in combination with the fourth information and other pieces of information), whether it is necessary to provide the policy rule used in the 5GS for the terminal device.

By taking the policy rule being a URSP rule as an example, in the case that the UE is in the EPS (which is initially registered or moves from the 5GS to the EPS), it is necessary to report a stored policy section identifier (PSI) list to the PCRF based on the attach procedure or a tracking area update (TAU) procedure. The PSI list is encapsulated in the container, forwarded on various nodes, and eventually transmitted to the PCRF. The PCRF determines, based on the acquired PSI list, policy content of the UE acquired from a unified data repository (UDR) and/or a local configuration policy, whether it is necessary to provide the URSP to the UE. In response to determining that it is necessary to provide the URSP to the UE, the PCRF transmits the URSP to the UE using the P-GW initiated bearer modification procedure.

In some embodiments, the URSP transmitted by the PCRF to the UE includes any one of the following cases.

In case 1, only the 5GS URSP is transmitted. The 5GS URSP means that RSD parameters in the URSP rule are related parameters for a 5G PDU session, that is, the policy is used on the UE in the 5GS.

In case 2, only the EPS URSP is transmitted. The EPS URSP means that RSD parameters in the URSP rule are related parameters for a 4G PDU connection, that is, the policy is used on the UE in the EPS.

In case 3, both the 5GS URSP and the EPS URSP are transmitted. In this case, each traffic descriptor corresponds to two sets of RSDs, one of the two sets of RSDs are in the 5GS, and the other sets of RSDs are in the EPS.

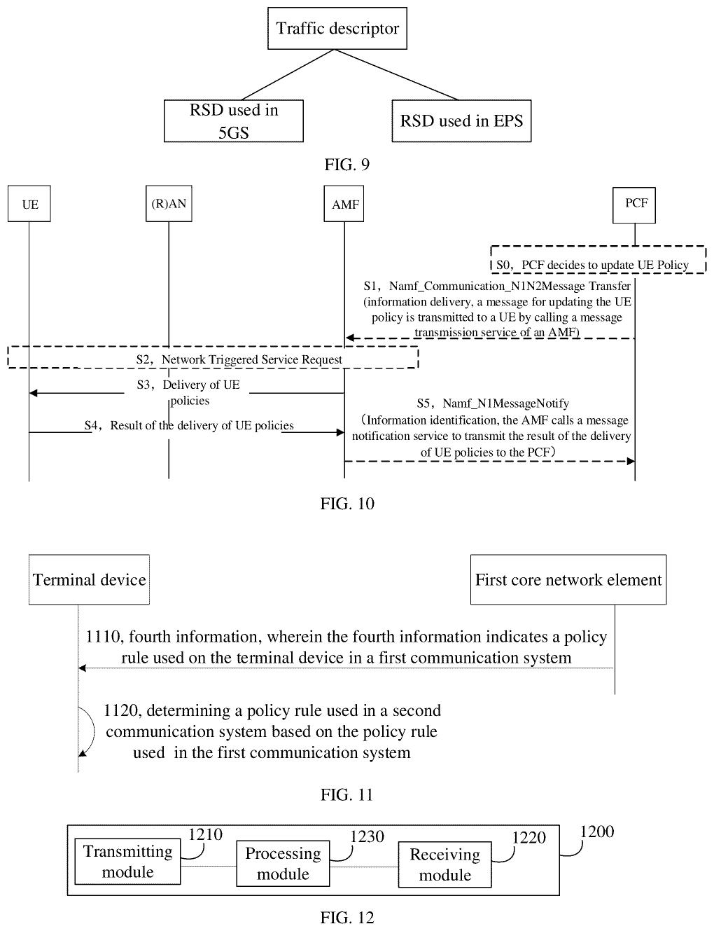

In the case that the UE only receives the 5GS URSP, the UE maps the RSDs in the URSP rule to acquire the RSD for the EPS in the traffic descriptor, as illustrated in FIG. 9. Conversely, in the case that the UE directly receives the EPS URSP, the UE maps the RSD for the 5GS with a same traffic descriptor. In the case that UE receives the 5GS URSP and the EPS URSP, the UE does not need to perform the mapping procedure, and directly acquires the RSD for the 5GS based on the 5GS URSP and acquires the RSD for the EPS based on the EPS URSP.

In some embodiments, the third information is transmitted based on the UCU procedure. In some embodiments, by taking the first communication system being an NR system (or 5GS) and the second communication system being an LTE system (or EPS) as an example, the first core network element is a PCF in the 5GS, the PCF transmits the third information based on the UCU procedure, and the policy rule used on the terminal device in the EPS is indicated by the third information.

Referring to FIG. 10, a schematic diagram of transmission of third information by a PCF based on a UCU procedure is illustrated. The flowchart includes the following procedures.
S0, a PCF decides to update UE policy.
S1, Namf_Communication_N1N2Message Transfer (a message for updating the UE policy is transmitted to a UE by calling a message transmission service of an AMF).
S2, network triggered service request.
S3, delivery of UE policies.
S4, result of the delivery of UE policies.
S5, Namf_N1MessageNotify (the AMF calls a message notification service to transmit the result of the delivery of UE policies to the PCF).

In some embodiments, the third information is carried in the Namf_Communication_N1N2Message Transfer and the delivery of UE policies. For example, the third information is carried in the container for transmission, and the immediate node (including the AMF, and the (R)AN illustrated in FIG. 10 (or the access network device or the station)) between the PCF and the UE transmits the third information carried in the container. The terminal device reads the third information carried in the container from the received message to acquire the policy rule used on the terminal device in the EPS and/or the 5GS.

For the URSP, as the PCF is supported to transmit a container including the URSP to the UE based on the UCU procedure in the case that the UE is in the 5G network, the URSP only needs to be extended to the 5GS URSP and the EPS URSP. That is, as shown in FIG. 9, for each URSP rule, a traffic descriptor includes two RSDs for the 5GS and the EPS.

In some embodiments, the transmission of the URSP by the PCF to the UE involves any one of the following cases.

In case 1, only the 5GS URSP is transmitted. The 5GS URSP means that RSD parameters in the URSP rule are related parameters for a 5G PDU session, that is, the policy is used on the UE in the 5GS.

In case 2, only the EPS URSP is transmitted. The EPS URSP means that RSD parameters in the URSP rule are related parameters for a 4G PDU connection, that is, the policy is used on the UE in the EPS.

In case 3, both the 5GS URSP and the EPS URSP are transmitted. In this case, each traffic descriptor corresponds to two sets of RSDs, one of the two sets of RSDs are in the 5GS, and the other set of RSDs are in the EPS.

In the case that the UE only receives the 5GS URSP, the UE maps the RSDs in the URSP rule to acquire the RSD for the EPS in the traffic descriptor, as illustrated in FIG. 9. On the contrary, in the case that the UE directly receives the EPS URSP, the UE maps the RSD for the 5GS with a same traffic descriptor. In the case that UE receives the 5GS URSP and the EPS URSP, the UE does not need to perform the mapping procedure, and directly acquires the RSD for the 5GS based on the 5GS URSP and acquires the RSD for the EPS based on the EPS URSP.

In the technical solutions according to the embodiments of the present disclosure, the core network element in the first communication system transmits the information to the terminal device, and the information indicates the policy rule used on the terminal device in the second communication system, such that the terminal device acquires the policy rule used in the second communication system from the first communication system, and cross-system configuration and transmission of the policy rule are achieved, which helps to enhance communication reliability.

For example, the terminal device acquires the URSP rule or other policy rules used in the 5GS from the EPS, or the terminal device acquires the URSP rule or other policy rules used in the EPS from the 5GS.

Referring to FIG. 11, a flowchart of a method for wireless communication according to some embodiments of the present disclosure is illustrated. The method is method is applicable to the network architecture illustrated in FIG. 1 to FIG. 3. The method includes at least one of S1110 and S1120.

In S1110, a first core network element transmits fourth information to a terminal device, wherein the fourth information indicates a policy rule used on the terminal device in a first communication system, and the first core network element is a core network element in a first communication system.

Correspondingly, the terminal device receives the fourth information from the first core network element.

In S1120, the terminal device determines a policy rule used in a second communication system based on the policy rule used on the terminal device in the first communication system, wherein the first communication system is different from the second communication system.

In some embodiments, the fourth information indicating the policy rule used on the terminal device in the first communication system may be construed as that the fourth information includes the policy rule used on the terminal device in the first communication system or that the fourth information includes identification information of the policy rule used on the terminal device in the first communication system, and the terminal device acquires the corresponding policy rule from other sources based on the identification information.

In some embodiments, the first communication system being different from the second communication system means that the first communication system and the second communication system are two different communication systems. For example, the first communication system and the second communication system have different system architectures. For example, the first communication system and the second communication system have different core network architectures. For example, the first communication system and the second communication system belong to different evolution versions.

In some embodiments, the first communication system is an EPS, and the second communication system is a 5GS. In the case that the first communication system is an EPS, the first core network element is an AMF or a PCF.

In some embodiments, the first communication system is a 5GS, and the second communication system is an EPS. In the case that the first communication system is a 5GS, the first core network element is an MME or a PCRF.

The EPS is also construed as an LTE system, an E-UTRA system, a 4G system, or others, and those skilled in the art understand the meanings. The 5GS is also construed as a 5G NR system, a 5G system, an NR system, or others, and those skilled in the art understand the meanings. The core network in the EPS is also construed as an EPC, and the core network in the 5GS is also construed as a 5GC.

In some embodiments, the first core network element is a core network element in the first communication system for managing the policy rule. For example, in the case that the first communication system is an NR system (or 5GS), the first core network element is a PCF. For example, in the case that the first communication system is an LTE system (or EPS), the first core network element is a PCRF.

In some embodiments, by taking the first communication system being an LTE system (or EPS) and the second communication system being an NR system (or 5GS) as an example, the first core network element is a core network element in the EPS, for example, a PCRF, and the PCRF transmits the fourth information to the terminal device. The fourth information indicates the policy rule used on the terminal device in the EPS. Upon receiving the fourth information, the terminal device acquires the policy rule used on the terminal device in the EPS, and then determines the policy rule used in the 5GS based on the policy rule used in the EPS.

In some embodiments, by taking the first communication system being an NR system (or 5GS) and the second communication system being an LTE system (or EPS) as an example, the first core network element is a core network element in the 5GS, for example, a PCF, and the PCF transmits the fourth information to the terminal device. The fourth information indicates the policy rule used on the terminal device in the 5GS. Upon receiving the fourth information, the terminal device acquires the policy rule used on the terminal device in the 5GS, and then determines the policy rule used in the EPS based on the policy rule used in the 5GS.

In some embodiments, the first communication system and the second communication system belong to a same operator.

In some embodiments, the first communication system and the second communication system belong to a same PLMN. For example, a PLMN ID of the first communication system is the same as a PLMN ID of the second communication system. Alternatively, the first communication system and the second communication system belong to different PLMNs. For example, a PLMN ID of the first communication system is different from a PLMN ID of the second communication system.

In some embodiments, a coverage range of the first communication system and a coverage range of the second communication system are the same or different. For example, assuming that the first communication system is an NR system, and the second communication system is an LTE system, then a coverage range of the NR system is generally smaller than a coverage range of the LTE system. For example, for an NR system (5G network) and an LTE system (4G network) in the same PLMN, a coverage range of the LTE system includes and is larger than a coverage range of the NR system, and thus the terminal device is likely to move the NR system (5G network) to the LTE system (4G network).

In some embodiments, the terminal device acquires the policy rule used in the second communication system by determining, based on a mapping relationship of the policy rules in the second communication system and the first communication system, a policy rule corresponding to the policy rule used in the first communication system.

Illustratively, the policy rule includes a URSP, and the terminal device determines, based on the mapping relationship of the policy rules in the second communication system and the first communication system, an RSD used in the second communication system and corresponding to an RSD used in the first communication system with a same traffic descriptor.

In some embodiments, the traffic descriptors are also mappable. For example, the traffic descriptor in the second communication system is mapped based on the traffic descriptor in the first communication system, and the terminal device uses the traffic descriptor in the first communication system in the case that the terminal device is in the first communication system and uses the traffic descriptor in the second communication system in the case that the terminal device is in in the second communication system. By taking the first communication system being a 5GS and the second communication system being an EPS as an example, the terminal device maps the traffic descriptor in the EPS based on the traffic descriptor in the 5GS, and the terminal device uses the traffic descriptor in the 5GS in the case that the terminal device accesses the 5G network and uses the traffic descriptor in the EPS in the case that the terminal device accesses the 4G network.

In some embodiments, the traffic descriptor in the second communication system and the RSD in the traffic descriptor are mapped based on the traffic descriptor in the first communication system and the RSD in the traffic descriptor, and the terminal device uses the traffic descriptor in the first communication system and the RSD in the traffic descriptor in the case that the terminal device is in the first communication system and uses the traffic descriptor in the second communication system and the RSD in the traffic descriptor in the case that the terminal device is in the second communication system. By taking the first communication system being a 5GS and the second communication system being an EPS as an example, the terminal device maps the traffic descriptor in the EPS and the RSD in the traffic descriptor based on the traffic descriptor in the 5GS and the RSD in the traffic descriptor, and the terminal device uses the traffic descriptor in the 5GS and the RSD in the traffic descriptor in the case that the terminal device accesses the 5G network and uses the traffic descriptor in the EPS and the RSD in the traffic descriptor in the case that the terminal device accesses the 4G network.

In some embodiments, the fourth information is carried in a container for transmission. For example, an immediate node between the first core network element and the terminal device transmits the fourth information carried in the container. The terminal device reads the fourth information carried in the container from a received message to acquire the policy rule provided by the network to the terminal device.

In some embodiments, the policy rule includes, but is not limited to, a URSP rule, a V2XP rule, a ProSeP rule, an ANDSP rule, or an ATSSS policy rule.

In some embodiments, the fourth information is transmitted based on the P-GW initiated bearer modification procedure. In some embodiments, the fourth information is transmitted based on the UCU procedure. For transmission modes of the fourth information based on the above two procedures, reference may be made to descriptions of transmission of the third information based on the above two procedures in the above embodiments, which are not described any further in the embodiments.

In the technical solutions according to the embodiments of the present disclosure, the core network element in the first communication system transmits the information to the terminal device, and the information indicates the policy rule used on the terminal device in the first communication system, such that the terminal device acquires the policy rule used in the first communication system from the first communication system to further self-deduces/self-map/self-determine the policy rule used in the second communication system, and the cross-system configuration and transmission of the policy rule are achieved, which helps to enhance communication reliability.

It should be noted that in the above method embodiments, procedures performed by the terminal device may be practiced as a method for wireless communication applicable to a terminal device, and procedures performed by the first core network element may be practiced as a method for wireless communication applicable to a first core network element. In addition, the embodiments of the present disclosure may be arbitrarily combined to form new embodiments, which fall within the scope of protection of the present disclosure.

The apparatus embodiments of the present disclosure are as follows, and are used to implement the method embodiments of the present disclosure. For details not disclosed in the apparatus embodiments of the present disclosure, reference may be made to the method embodiments of the present disclosure.

Referring to FIG. 12, a schematic block diagram of an apparatus for wireless communication according to some embodiments of the present disclosure is illustrated. The apparatus has functions for performing the method embodiments applicable to the terminal device, and the functions are implemented by running corresponding software by hardware. The apparatus is the terminal device, or is configured in the terminal device. As illustrated in FIG. 12, the apparatus 1200 includes a transmitting module 1210 and/or a receiving module 1220.

The transmitting mode 1210 is configured to transmit first information to a first core network element, wherein the first information indicates support or allowance of a policy rule on a terminal device in a case that the terminal device is connected to a second communication system; and
the receiving module 1220 is configured to receive second information from a first core network element, wherein the second information indicates support or allowance of a policy rule on a network in a case that a terminal device is connected to a second communication system;
wherein the first core network element is a core network element in a first communication system, and the first communication system is different from the second communication system.

In some embodiments, the first information indicates at least one of: information indicating whether the terminal device supports configuring the policy rule in the second communication system; information indicating whether the terminal device supports using the policy rule in the second communication system; or information indicating whether the terminal device supports mapping of policy rules between the first communication system and the second communication system.

In some embodiments, in a case that the first information indicates that the terminal device does not support configuring the policy rule in the second communication system, the receiving module 1220 is further configured to receive a policy rule used in the second communication system from the first core network element; or the receiving module 1220 is further configured to receive a policy rule used in the first communication system from the first core network element, and the apparatus 1200 further includes a processing module 1230, configured to determine, based on the policy rule used in the first communication system, a policy rule used in the second communication system.

In some embodiments, in a case that the first information indicates that the terminal device supports configuring the policy rule in the second communication system, the receiving module 1220 is further configured to receive a policy rule used in the first communication system from the first core network element; and/or, the receiving module 1220 is further configured to receive a policy rule used in the second communication system from a second core network element, wherein the second core network element is a core network element in the second communication system.

In some embodiments, in a case that the first information indicates that the terminal device does not support using the policy rule in the second communication system, the receiving module 1220 is further configured to receive a policy rule used in the first communication system from the first core network element.

In some embodiments, in a case that the first information indicates that the terminal device supports using the policy rule in the second communication system, the receiving module 1220 is further configured to receive a policy rule used in the second communication system from the first core network element; or, the receiving module 1220 further is configured to receive a policy rule used in the first communication system from the first core network element, and the apparatus 1200 further includes a processing module 1230, configured to determine, based on the policy rule used in the first communication system, a policy rule used in the second communication system.

In some embodiments, in a case that the first information indicates that the terminal device supports mapping of the policy rules between the first communication system and the second communication system, the receiving module 1220 is further configured to receive a policy rule used in the first communication system from the first core network element; the apparatus 1200 further includes a processing module 1230, configured to determine, based on the policy rule used in the first communication system, a policy rule used in the second communication system; the receiving module 1220 is further configured to receive a policy rule used in the second communication system from the first core network element; or the apparatus 1200 further includes a processing module 1230, configured to determine, based on the policy rule used in the second communication system, a policy rule used in the first communication system; or, the receiving module 1220 is further configured to receive a policy rule used in the first communication system and a policy rule used in the second communication system from the first core network element.

In some embodiments, in a case that the first information indicates that the terminal device does not support mapping of the policy rules between the first communication system and the second communication system, the receiving module 1220 is further configured to receive a policy rule used in the first communication system and/or a policy rule used in the second communication system from the first core network element.

In some embodiments, the second information indicates at least one of: information indicating whether the network supports transmitting the policy rule to the terminal device in the case that the terminal device is connected to the second communication system; or information indicating whether the network allows the terminal device to use the policy rule in the second communication system.

In some embodiments, in a case that the second information indicates that the network does not support transmitting the policy rule to the terminal device in the case that the terminal device is connected to the second communication system, the receiving module 1220 is further configured to receive a policy rule used in the second communication system from the first core network element; or, the receiving module 1220 is further configured to receive a policy rule used in the first communication system from the first core network element; and the apparatus 1200 further includes a processing module 1230, configured to determine, based on the policy rule used in the first communication system, a policy rule used in the second communication system.

In some embodiments, in a case that the second information indicates that the network supports transmitting the policy rule to the terminal device in the case that the terminal device is connected to the second communication system, the receiving module 1220 is further configured to receive a policy rule used in the first communication system from the first core network element; and/or, the receiving module 1220 is further configured to receive a policy rule used in the second communication system from a second core network element, wherein the second core network element is a core network element in the second communication system.

In some embodiments, in a case that the second information indicates that the network allows the terminal device to use the policy rule in the second communication system, the receiving module 1220 is further configured to receive a policy rule used in the first communication system and/or a policy rule used in the second communication system from the first core network element.

In some embodiments, in a case that the second information indicates that the network does not allow the terminal device to use the policy rule in the second communication system, the receiving module 1220 is further configured to receive a policy rule used in the first communication system from the first core network element.

In some embodiments, the first information is carried in a registration request message or an attach request message.

In some embodiments, the registration request message or the attach request message contains a first container, wherein the first container contains the first information.

In some embodiments, the second information is carried in a reply message corresponding to a registration request message or an attach request message.

In some embodiments, the reply message includes a second container, wherein the second container contains the second information.

In some embodiments, the registration request message includes at least on of: an initial registration request message, a periodic registration request message, or a location-updated registration request message.

In some embodiments, the first communication system is an EPS, and the second communication system is a 5GS; or the first communication system is a 5GS, and the second communication system is an EPS.

In some embodiments, the policy rule includes at least one of: a URSP rule, a V2XP rule, a ProScP rule, an ANDSP rule, or an ATSSS policy rule.

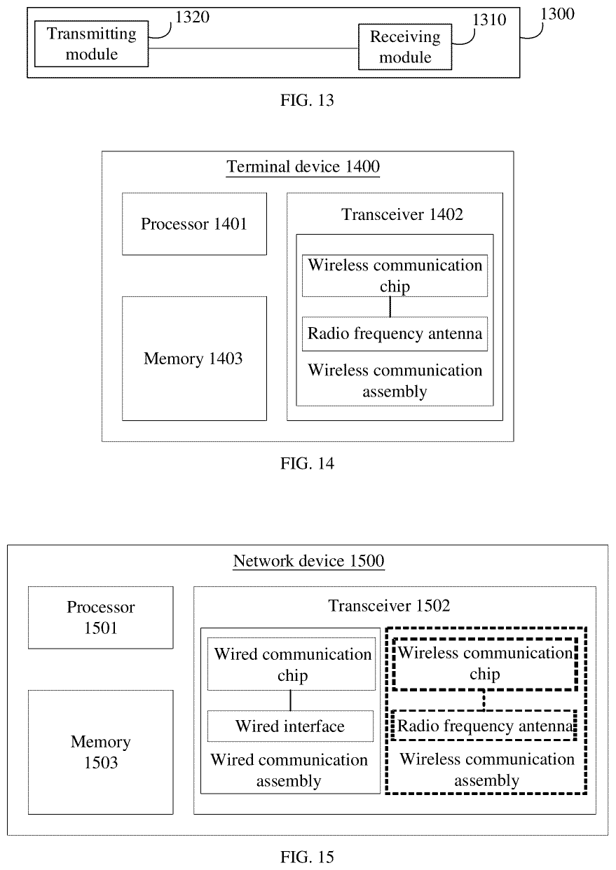

Referring to FIG. 13, a schematic block diagram of an apparatus for wireless communication according to some embodiments of the present disclosure is illustrated. The apparatus has functions for performing the method embodiments applicable to the first core network element, and the functions are implemented by running corresponding software by hardware. The apparatus is the first core network element, or is configured in the first core network element. As illustrated in FIG. 13, the apparatus 1300 includes a receiving module 1310 and/or a transmitting module 1320.

The receiving module 1310 is configured to receive first information from a terminal device, wherein the first information indicates support or allowance of a policy rule on the terminal device in a case that the terminal device is connected to a second communication system; and
the transmitting module 1320 is configured to transmit second information to a terminal device, wherein the second information indicates support or allowance of a policy rule on a network in a case that the terminal device is connected to a second communication system;
wherein a first core network element is a core network element in a first communication system, and the first communication system is different from the second communication system.

In some embodiments, the first information indicates at least one of: information indicating whether the terminal device supports configuring the policy rule in the second communication system; information indicating whether the terminal device supports using the policy rule in the second communication system; or information indicating whether the terminal device supports mapping of policy rules between the first communication system and the second communication system.

In some embodiments, in a case that the first information indicates that the terminal device does not support configuring the policy rule in the second communication system, the transmitting module 1320 is further configured to transmit a policy rule used in the second communication system to the terminal device; or, the transmitting module 1320 is further configured to transmit a policy rule used in the first communication system to the terminal device, wherein the policy rule used in the first communication system is configured to determine a policy rule used in the second communication system.

In some embodiments, in a case that the first information indicates that the terminal device supports configuring the policy rule in the second communication system, the transmitting module 1320 is further configured to transmit a policy rule used in the first communication system to the terminal device; and/or, a second core network element transmits a policy rule used in the second communication system to the terminal device, wherein the second core network element is a core network element in the second communication system.

In some embodiments, in a case that the first information indicates that the terminal device does not support using the policy rule in the second communication system, the transmitting module 1320 is further configured to transmit a policy rule used in the first communication system to the terminal device.

In some embodiments, in a case that the first information indicates that the terminal device supports using the policy rule in the second communication system, the transmitting module 1320 is further configured to transmit a policy rule used in the second communication system to the terminal device; or, the transmitting module 1320 is further configured to transmit a policy rule used in the first communication system to the terminal device, wherein the policy rule used in the first communication system is configured to determine a policy rule used in the second communication system.

In some embodiments, in a case that the first information indicates that the terminal device supports mapping of the policy rules between the first communication system and the second communication system, the transmitting module 1320 is further configured to transmit a policy rule used in the first communication system to the terminal device, wherein the policy rule used in the first communication system is configured to determine a policy rule used in the second communication system; the transmitting module 1320 is further configured to transmit a policy rule used in the second communication system to the terminal device, wherein the policy rule used in the second communication system is configured to determine a policy rule used in the first communication system; or, the transmitting module 1320 is further configured to transmit a policy rule used in the first communication system and a policy rule used in the second communication system to the terminal device.

In some embodiments, in a case that the first information indicates that the terminal device does not support mapping of the policy rules between the first communication system and the second communication system, the transmitting module 1320 is further configured to transmit a policy rule used in the first communication system and/or a policy rule used in the second communication system to the terminal device.

In some embodiments, the second information indicates at least one of: information indicating whether the network supports transmitting the policy rule to the terminal device in the case that the terminal device is connected to the second communication system; or information indicating whether the network allows the terminal device to use the policy rule in the second communication system.

In some embodiments, in a case that the second information indicates that the network does not support transmitting the policy rule to the terminal device in the case that the terminal device is connected to the second communication system, the transmitting module 1320 is further configured to transmit a policy rule used in the second communication system to the terminal device; or, the transmitting module 1320 is further configured to transmit a policy rule used in the first communication system to the terminal device, wherein the policy rule used in the first communication system is configured to determine a policy rule used in the second communication system.

In some embodiments, in a case that the second information indicates that the network supports transmitting the policy rule to the terminal device in the case that the terminal device is connected to the second communication system, the transmitting module 1320 is further configured to transmit a policy rule used in the first communication system to the terminal device; and/or, a second core network element transmits a policy rule used in the second communication system to the terminal device, wherein the second core network element is a core network element in the second communication system.

In some embodiments, in a case that the second information indicates that the network allows the terminal device to use the policy rule in the second communication system, the transmitting module 1320 is further configured to transmit a policy rule used in the first communication system and/or a policy rule used in the second communication system to the terminal device.

In some embodiments, in a case that the second information indicates that the network does not allow the terminal device to use the policy rule in the second communication system, the transmitting module 1320 is further configured to transmit a policy rule used in the first communication system to the terminal device.

In some embodiments, the first information is carried in a registration request message or an attach request message.

In some embodiments, the registration request message or the attach request message contains a first container, wherein the first container contains the first information.

In some embodiments, the second information is carried in a reply message corresponding to a registration request message or an attach request message.

In some embodiments, the reply message includes a second container, wherein the second container contains the second information.

In some embodiments, the registration request message includes at least on of: an initial registration request message, a periodic registration request message, or a location-updated registration request message.

In some embodiments, the first communication system is an EPS, and the second communication system is a 5GS; or the first communication system is a 5GS, and the second communication system is an EPS.

In some embodiments, the policy rule includes at least one of: a URSP rule, a V2XP rule, a ProSeP rule, an ANDSP rule, or an ATSSS policy rule.

Some embodiments of the present disclosure further provide an apparatus for wireless communication. The apparatus has functions for performing the method embodiments applicable to the terminal device, and the functions are implemented by hardware or by running corresponding software by hardware. The apparatus is the terminal device, or is configured in the terminal device. Referring to FIG. 12, the apparatus 1200 includes a receiving module 1220.

The receiving module 1220 is configured to receive third information from a first core network element, wherein the first core network element is a core network element in a first communication system, the third information indicates a policy rule used on a terminal device in a second communication system, and the first communication system is different from the second communication system.

In some embodiments, as illustrated in FIG. 12, the apparatus 1200 further includes a processing module 1230, configured to determine, based on the policy rule used in the second communication system, a policy rule used in the first communication system.

In some embodiments, the processing module 1230 is configured to acquire the policy rule used in the first communication system by determining, based on a mapping relationship of the policy rules in the second communication system and the first communication system, a policy rule corresponding to the policy rule used in the second communication system.

In some embodiments, the policy rule includes a URSP rule, and the processing module 1230 is configured to determine, based on the mapping relationship of the policy rules in the second communication system and the first communication system, an RSD used in the first communication system and corresponding to an RSD used in the second communication system with a same traffic descriptor.

In some embodiments, the third information further indicates a policy rule used on the terminal device in the first communication system.

In some embodiments, the policy rule includes a URSP rule, and the third information includes an RSD used in the second communication system and an RSD used in the first communication system with a same traffic descriptor.

In some embodiments, the third information includes the policy rule used on the terminal device in the second communication system.

In some embodiments, the first communication system is an EPS, and the second communication system is a 5GS; or the first communication system is a 5GS, and the second communication system is an EPS.

In some embodiments, the third information or the fourth information is transmitted based on a P-GW initiated bearer modification procedure.

In some embodiments, the third information is transmitted based on a UCU procedure.

In some embodiments, the third information is carried in a container for transmission.

In some embodiments, the policy rule includes at least one of: a URSP rule, a V2XP rule, a ProSeP rule, an ANDSP rule, or an ATSSS policy rule.

Some embodiments of the present disclosure further provide an apparatus for wireless communication. The apparatus has functions for performing the method embodiments applicable to the first core network element, and the functions are implemented by hardware or by running corresponding software by hardware. The apparatus is the first core network element, or is configured in the first core network element. Referring to FIG. 13, the apparatus 1300 includes a transmitting module 1320.

The transmitting module 1320 is configured to transmit third information to a terminal device, wherein a first core network element is a core network element in a first communication system, the third information indicates a policy rule used on the terminal device in a second communication system, and the first communication system is different from the second communication system.

In some embodiments, a policy rule used on the terminal device in the first communication system is determined based on the policy rule used in the second communication system.

In some embodiments, the policy rule used on the terminal device in the first communication system is determined based on the policy rule used in the second communication system and a mapping relationship of the policy rules in the second communication system and the first communication system.

In some embodiments, the policy rule includes a URSP rule, and an RSD used on the terminal device in the first communication system is determined based on the mapping relationship of the policy rules in the second communication system and the first communication system and an RSD used in the second communication system with a same traffic descriptor.

In some embodiments, the third information further indicates a policy rule used on the terminal device in the first communication system.

In some embodiments, the policy rule includes a URSP rule, and the third information includes an RSD used in the second communication system and an RSD used in the first communication system with a same traffic descriptor.

In some embodiments, the third information includes the policy rule used on the terminal device in the second communication system.

In some embodiments, the first communication system is an EPS, and the second communication system is a 5GS; or the first communication system is a 5GS, and the second communication system is an EPS.

In some embodiments, the third information or the fourth information is transmitted based on a P-GW initiated bearer modification procedure.

In some embodiments, the third information is transmitted based on a UCU procedure.

In some embodiments, the third information is carried in a container for transmission.

In some embodiments, the policy rule includes at least one of: a URSP rule, a V2XP rule, a ProScP rule, an ANDSP rule, or an ATSSS policy rule.

Some embodiments of the present disclosure further provide an apparatus for wireless communication. The apparatus has functions for performing the method embodiments applicable to the terminal device, and the functions are implemented by hardware or by running corresponding software by hardware. The apparatus is the terminal device, or is configured in the terminal device. Referring to FIG. 12, the apparatus 1200 includes a receiving module 1220 and a processing module 1230.

The receiving module 1220 is configured to receive fourth information from a first core network element, wherein the fourth information indicates a policy rule used on a terminal device in a first communication system, and the first core network element is a core network element in a first communication system.

The processing module 1230 is configured to determine, based on the policy rule used in the first communication system, a policy rule used in a second communication system, wherein the first communication system is different from the second communication system.

In some embodiments, the processing module 1230 is configured to acquire the policy rule used in the second communication system by determining, based on a mapping relationship of the policy rules in the first communication system and the second communication system, a policy rule corresponding to the policy rule used in the first communication system.

In some embodiments, the policy rule includes a URSP rule, and the processing module 1230 is configured to determine, based on the mapping relationship of the policy rules in the first communication system and the second communication system, an RSD used in the second communication system and corresponding to an RSD used in the first communication system with a same traffic descriptor.

In some embodiments, the fourth information includes the policy rule used on the terminal device in the first communication system.

In some embodiments, the first communication system is an EPS, and the second communication system is a 5GS; or the first communication system is a 5GS, and the second communication system is an EPS.

In some embodiments, the fourth information or the fourth information is transmitted based on a P-GW initiated bearer modification procedure.

In some embodiments, the fourth information is transmitted based on a UCU procedure.

In some embodiments, the fourth information is carried in a container for transmission.

In some embodiments, the policy rule includes at least one of: a URSP rule, a V2XP rule, a ProSeP rule, an ANDSP rule, or an ATSSS policy rule.

Some embodiments of the present disclosure further provide an apparatus for wireless communication. The apparatus has functions for performing the method embodiments applicable to the first core network element, and the functions are implemented by hardware or by running corresponding software by hardware. The apparatus is the first core network element, or is configured in the first core network element. Referring to FIG. 13, the apparatus 1300 includes a transmitting module 1320.

The transmitting module is configured to transmit fourth information to a terminal device, wherein the fourth information indicates a policy rule used on the terminal device in a first communication system, wherein the policy rule used in the first communication system is configured to determine a policy rule used in the second communication system, the first core network element is a core network element in a first communication system, and the first communication system is different from the second communication system.

In some embodiments, in a case that the fourth information is transmitted, the policy rule used on the terminal device in the second communication system is determined based on a policy rule used in the first communication system and a mapping relationship of the policy rules in the first communication system and the second communication system.

In some embodiments, the policy rule includes a URSP rule, and an RSD used on the terminal device in the second communication system is determined based on the mapping relationship of the policy rules in the first communication system and the second communication system and an RSD used in the first communication system with a same traffic descriptor.

In some embodiments, the fourth information includes the policy rule used on the terminal device in the first communication system.

In some embodiments, the first communication system is an EPS, and the second communication system is a 5GS; or the first communication system is a 5GS, and the second communication system is an EPS.

In some embodiments, the fourth information or the fourth information is transmitted based on a P-GW initiated bearer modification procedure.

In some embodiments, the fourth information is transmitted based on a UCU procedure.

In some embodiments, the fourth information is carried in a container for transmission.

In some embodiments, the policy rule includes at least one of: a URSP rule, a V2XP rule, a ProSeP rule, an ANDSP rule, or an ATSSS policy rule.

It should be noted that in the case that the apparatus in the above embodiment achieves its functions, division of the above functional modules are illustrated. In practical application, the above functions are designated to different functional modules according to actual needs. That is, the apparatus is divided into different functional modules to implements all or part of the above functions.

With respect to the apparatus in the above embodiments, the specific execution methods of the modules are described in detail in the method embodiments, which are not described in detail herein.

Referring to FIG. 14, a schematic structural diagram of a terminal device according to some embodiments of the present disclosure is illustrated. The terminal device 1400 includes: a processor 1401, a transceiver 1402, and a processor 1403.

The processor 1401 includes one or more processing cores, and achieves various functional applications and information processing by running software programs and modules.

The transceiver 1402 includes a receiver and a transmitter. For example, the receiver and the receiver are practiced as a wireless communication assembly, and the wireless communication assembly includes a wireless communication chip and a radio frequency antenna.

The memory 1403 is connected to the processor 1401 and the transceiver 1402.

The memory 1403 is configured to store one or more computer programs, and the processor 1401, when loading and running the one or more computer programs, is caused to perform various processes performed by the terminal device in the above method embodiments.

In addition, the memory 1403 is practiced by any type of volatile or non-volatile storage device or combinations thereof. The volatile or non-volatile storage device includes but is not limited to a disk or optical disc, an electrically-erasable programmable read-only memory (EEPROM), an erasable programmable read-only memory (EPROM), a static random access memory (SRAM), a read-only memory (ROM), a magnetic memory, a flash memory, or a programmable read-only memory (PROM).

In some embodiments, the transceiver 1402 is configured to: transmit first information to the first core network element, wherein the first information indicates support or allowance of a policy rule on the terminal device in a case that the terminal device is connected to a second communication system; and/or receive second information from the first core network element, wherein the second information indicates support or allowance of a policy rule on a network in a case that the terminal device is connected to a second communication system; wherein a first core network element is a core network element in a first communication system, and the first communication system is different from the second communication system.

In some embodiments, the transceiver 1402 is configured to receive third information from a first core network element, wherein a first core network element is a core network element in a first communication system, the third information indicates a policy rule used on a terminal device in a second communication system, and the first communication system is different from the second communication system.

In some embodiments, the transceiver 1402 is configured to receive fourth information from a first core network element, wherein the fourth information indicates a policy rule used on a terminal device in a first communication system, and the first core network element is a core network element in a first communication system. The processing module 1401 is configured to determine, based on the policy rule used in the first communication system, a policy rule used in a second communication system, wherein the first communication system is different from the second communication system.

For details not described in the embodiments, reference may be made to the above embodiments, which are not described herein any further.

Referring to FIG. 15, a schematic structural diagram of a network device according to some embodiments of the present disclosure is illustrated. The terminal device 1500 includes: a processor 1501, a transceiver 1502, and a processor 1503.

The processor 1501 includes one or more processing cores, and achieves various functional applications and information processing by running software programs and modules.

The transceiver 1502 includes a receiver and a transmitter. For example, the transceiver 1502 includes a wired communication assembly, and the wired communication assembly includes a wired communication chip and a wired interface (for example, a fiber Interface). In some embodiments, the transceiver 1502 includes a wireless communication assembly, and the wireless communication assembly includes a wireless communication chip and a radio frequency antenna.

The memory 1503 is connected to the processor 1501 and the transceiver 1502.

The memory 1503 is configured to store one or more computer programs, and the processor 1501, when loading and running the one or more computer programs, is caused to perform various processes performed by the first core network element in the above method embodiments.

In addition, the memory 1503 is practiced by any type of volatile or non-volatile storage device or combinations thereof. The volatile or non-volatile storage device includes but is not limited to a disk or optical disc, an EEPROM, an EPROM, an SRAM, a ROM, a magnetic memory, a flash memory, or a PROM.

In some embodiments, the transceiver 1502 is configured to: receive first information from a terminal device, wherein the first information indicates support or allowance of a policy rule on the terminal device in a case that the terminal device is connected to a second communication system; and/or transmit second information to the terminal device, wherein the second information indicates support or allowance of a policy rule on a network in a case that the terminal device is connected to a second communication system; wherein a first core network element is a core network element in a first communication system, and the first communication system is different from the second communication system.

In some embodiments, the transceiver 1502 is configured to transmit third information to the terminal device, wherein a first core network element is a core network element in a first communication system, the third information indicates a policy rule used on a terminal device in a second communication system, and the first communication system is different from the second communication system.

In some embodiments, the transceiver 1502 is configured to transmit fourth information to the terminal device, wherein the fourth information indicates a policy rule used on a terminal device in a first communication system, the policy rule used in the first communication system is configured to determine a policy rule used in the second communication system, and the first core network element is a core network element in the first communication system, and the first communication system is different from the second communication system.

For details not described in the embodiments, reference may be made to the above embodiments, which is not described herein any further.

Some embodiments of the present disclosure further provide a computer-readable storage medium storing one or more computer programs, wherein the one or more computer programs, when loaded and run by a processor in a terminal device, cause the terminal device to perform the method for wireless communication applicable to the terminal device.

Some embodiments of the present disclosure further provide a computer-readable storage medium storing one or more computer programs, wherein the one or more computer programs, when loaded and run by a processor in a network device (for example, a first core network element), cause the network device (for example, the first core network element) to perform the method for wireless communication applicable to the terminal device (for example, the first core network element).

In some embodiments, the computer-readable storage medium includes: a ROM, a random access memory (RAM), a solid state drive (SSD), an optical disc, or the like. The RAM includes a resistance random access memory (ReRAM) and a dynamic random access memory (DRAM).

Some embodiments of the present disclosure further provide a chip. The chip includes programmable logic circuity and/or program instructions, wherein the chip, when running on a terminal device, causes the terminal device to perform the method for wireless communication applicable to the terminal device.

Some embodiments of the present disclosure further provide a chip. The chip includes programmable logic circuity and/or program instructions, wherein the chip, when running on a network device (for example, a first core network element), causes the network device (for example, the first core network element) to perform the method for wireless communication applicable to the network device (for example, the first core network element).

Some embodiments of the present disclosure further provide a computer program product or a computer program including one or more computer instructions therein. The one or more computer instructions are stored in a computer-readable storage medium, and when loaded and executed by a processor in a terminal device, cause the terminal device to perform the method for wireless communication applicable to the terminal device.

Some embodiments of the present disclosure further provide a computer program product or a computer program including one or more computer instructions therein. The one or more computer instructions are stored in a computer-readable storage medium, and when loaded and executed by a processor in a network device (for example, a first core network element), cause the network device (for example, the first core network element) to perform the method for wireless communication applicable to the network device (for example, the first core network element).

It should also be understood that the term “indication” in the embodiments of the present disclosure refers to direct or indirect indication, or an associated relationship. Illustratively, in the case that A indicates B, it means that: A directly indicates B, for example, B can be acquired through A; A indirectly indicates B, for example, A indicates C, and B can be acquired through C; or A and B have an association relationship.

In some embodiments of the present disclosure, the term “correspondence” means that there is a direct correspondence or indirect correspondence between the two objects, there is an association between the two objects, or there is a relationship of indicating and being indicated, configuring and being configured, or the like.

In some embodiments of the present disclosure, the term “predefined” is practiced by pre-storing corresponding codes or forms in the device (including, for example, a network device and a terminal device) or other means for indicating relevant information, and specific implementations are not limited in the present disclosure. For example, the predefinition is defined in the protocol.

In some embodiments of the present disclosure, the “protocol” is a standard protocol in the communication field, and includes, for example, an LTE protocol, an NR protocol, and related protocols used in the future communication system, which is not limited in the present disclosure.

The term “a plurality of” herein means two or more. The term “and/or” herein describes associations between associated objects, and indicates three types of relationships. For example, the phrase “A and/or B” means (A), (B), or (A and B). The symbol “/” generally indicates an “or” relationship between the associated objects.

In addition, the serial number of the processes described herein only illustrates a possible sequence of performing the processes. In some embodiments, the above processes may be not performed in the above serial number, for example, processes of two different serial numbers are performed simultaneously, or processes of two different serial numbers are performed in an order opposite to that illustrated in the drawing, which is not limited in the present disclosure.

It should be understood by those skilled in the art that in the above one or more embodiments, functions described in the embodiments of the present disclosure are practiced by the hardware, the software, the firmware or any combinations thereof. In the case that the functions are practiced by the software, the functions are stored in the computer-readable storage medium or are determined as one or more instructions or codes in the computer-readable storage medium for transmission. The computer-readable storage medium includes a computer storage medium and a communication medium, and the communication medium includes any medium facilitating transmission of the computer program from one place to another place. The storage medium is any available medium accessible by a general or specific computer.

Described above are merely exemplary embodiments of the present disclosure, and are not intended to limit the present disclosure. Any modifications, equivalent replacements, improvements and the like made within the spirit and principles of the present disclosure should be encompassed within the scope of protection of the present disclosure.

1. A method for wireless communication, applicable to a terminal device, the method comprising:
transmitting first information to a first core network element, wherein the first information indicates whether the terminal device supports configuring a policy rule in a second communication system, the first core network element is a core network element in a first communication system, and the first communication system is different from the second communication system.

2. The method according to claim 1, wherein the first core network element is a policy control function.

3. The method according to claim 1, wherein in a case that the first information indicates that the terminal device supports configuring the policy rule in the second communication system, the method further comprises:
receiving a policy rule used in the first communication system from the first core network element;
receiving a policy rule used in the second communication system from the first core network element; and/or
receiving a policy rule used in the second communication system from a second core network element, wherein the second core network element is a core network element in the second communication system.

4. The method according to claim 1, wherein the first information is carried in a registration request message or an attach request message.

5. The method according to claim 4, wherein the registration request message or the attach request message contains a first container, wherein the first container contains the first information.

6. The method according to claim 1, wherein
the first communication system is an evolved packet system (EPS), and the second communication system is a 5^{th} generation mobile communication system (5GS); or
the first communication system is a 5^{th} generation mobile communication system (5GS), and the second communication system is an evolved packet system (EPS).

7. The method according to claim 1, wherein the policy rule comprises at least one of: a user equipment route selection policy (URSP) rule, a vehicle-to-everything policy (V2XP) rule, a proximity service policy (ProSeP) rule, an access network discovery and selection policy (ANDSP) rule, or an access traffic steering, switching and splitting (ATSSS) policy rule.

8. A communication device, comprising: a processor and a memory storing one or more computer programs; wherein the processor, when loading and running the one or more computer programs, is caused to:
transmit first information to a first core network element, wherein the first information indicates whether the terminal device supports configuring a policy rule in a the second communication system, the first core network element is a core network element in a first communication system, and the first communication system is different from the second communication system.

9. The communication device according to claim 8, wherein the processor, when loading and running the one or more computer programs, is caused to:
receive a policy rule used in the first communication system from the first core network element;
receive a policy rule used in the second communication system from the first core network element; and/or
receive a policy rule used in the second communication system from a second core network element, wherein the second core network element is a core network element in the second communication system.

10. The communication device according to claim 8, wherein the first information is carried in a registration request message or an attach request message.

11. The communication device according to claim 10, wherein the registration request message or the attach request message contains a first container, wherein the first container contains the first information.

12. The communication device according to claim 8, wherein
the first communication system is an evolved packet system (EPS), and the second communication system is a 5^{th} generation mobile communication system (5GS); or
the first communication system is a 5^{th} generation mobile communication system (5GS), and the second communication system is an evolved packet system (EPS).

13. The communication device according to claim 8, wherein the policy rule comprises at least one of: a user equipment route selection policy (URSP) rule, a vehicle-to-everything policy (V2XP) rule, a proximity service policy (ProSeP) rule, an access network discovery and selection policy (ANDSP) rule, or an access traffic steering, switching and splitting (ATSSS) policy rule.

14. A communication device, applicable to a first core network element, the communication device comprising: a processor and a memory storing one or more computer programs; wherein the processor, when loading and running the one or more computer programs, is caused to:
receive first information from a terminal device, wherein the first information indicates whether the terminal device supports configuring a policy rule in a second communication system, the first core network element is a core network element in a first communication system, and the first communication system is different from the second communication system.

15. The communication device according to claim 14, wherein the first core network element is a policy control function.

16. The communication device according to claim 14, wherein the processor, when loading and running the one or more computer programs, is caused to:
transmit a policy rule used in the first communication system to the terminal device;
transmit a policy rule used in the second communication system to the terminal device; and/or
transmit, by a second core network element, a policy rule used in the second communication system to the terminal device, wherein the second core network element is a core network element in the second communication system.

17. The communication device according to claim 14, wherein the first information is carried in a registration request message or an attach request message.

18. The communication device according to claim 17, wherein the registration request message or the attach request message contains a first container, wherein the first container contains the first information.

19. The communication device according to claim 14, wherein
the first communication system is an evolved packet system (EPS), and the second communication system is a 5^{th} generation mobile communication system (5GS); or
the first communication system is a 5^{th} generation mobile communication system (5GS), and the second communication system is an evolved packet system (EPS).

20. The communication device according to claim 14, wherein the policy rule comprises at least one of: a user equipment route selection policy (URSP) rule, a vehicle-to-everything policy (V2XP) rule, a proximity service policy (ProSeP) rule, an access network discovery and selection policy (ANDSP) rule, or an access traffic steering, switching and splitting (ATSSS) policy rule.
